(19) United States
(12) Patent Application Publication
(10) Pub. No.: US 2026/0311450 A1
(43) Pub. Date: Oct. 8, 2026

(54) SYSTEMS, METHODS, AND MEDIA FOR DETECTING ANOMALOUS PAIRS OF IMAGES OF AN OBJECT TYPE

(71) Applicant: Marquette University, Milwaukee, WI (US)

(72) Inventors: Mohamed Ibrahim, Brookfield, WI (US); Meisam Omidi, Milwaukee, WI (US)

(73) Assignee: Marquette University, Milwaukee, WI (US)

(21) Appl. No.: 19/636,397

(22) Filed: Apr. 1, 2026

Related U.S. Application Data
(60) Provisional application No. 63/783,375, filed on Apr. 4, 2025.

(51) Int. Cl. G06V 10/74; G06T 7/00; G06V 10/82; G09B 23/28

(52) U.S. Cl. CPC G06V 10/761; G06T 7/0016; G06V 10/82; G09B 23/286; G06T 2207/10116; G06T 2207/20081; G06T 2207/20084; G06T 2207/30036; G06V 2201/03

(57) ABSTRACT

In accordance with some embodiments, systems, methods, and media for detecting a pair of anomalous images are provided. In some embodiments, the system comprises: one or more hardware processors configured to: receive a first image that includes one or more objects; receive a second image that includes one or more objects; provide the first image and the second image as input to a trained machine learning model that is trained to predict whether the same object is included in both the first image and the second image; receive, from the trained machine learning model, an output indicative of whether the first image and the second image include the same object; cause information indicating whether the first image and the second image include the same object to be presented to a user.

### CROSS-REFERENCE TO RELATED APPLICATIONS

This application claims the benefit of, and claims priority to, U.S. Provisional Applications 63/783,375, filed Apr. 4, 2025, which is hereby incorporated herein by reference in its entirety for all purposes.

### BACKGROUND

Academic integrity is crucial in dental education, especially during practical exams that assess competencies. Traditional oversight may not detect sophisticated examples of academic dishonesty, such as radiograph substitution or tampering.

### SUMMARY

In accordance with some embodiments of the disclosed subject matter, a system for detecting a pair of anomalous images is provided, the system comprising: one or more hardware processors configured to: receive a first image that includes one or more objects; receive a second image that includes one or more objects; provide the first image and the second image as input to a trained machine learning model that is trained to predict whether the same object is included in both the first image and the second image; receive, from the trained machine learning model, an output indicative of whether the first image and the second image include the same object; cause information indicating whether the first image and the second image include the same object to be presented to a user.

In some embodiments, the system further comprises: a radiograph device, wherein the second image is a radiograph captured using the radiograph device; wherein the one or more hardware processors are further configured to: capture the second image using the radiograph device.

In some embodiments, the first image is a radiograph that includes a first representation of a tooth before a treatment procedure is performed, and the second image is a radiograph the includes a second representation of a tooth after at least a portion of the treatment procedure has been performed.

In some embodiments, the output is indicative of whether the first representation of the tooth and the second representation of the tooth are representations of a first tooth.

In some embodiments, the treatment procedure is a nonsurgical root canal treatment.

In some embodiments, the first tooth is a plastic tooth, and the nonsurgical root canal treatment is part of a practical examination.

In some embodiments, the one or more hardware processors are further configured to: receive a plurality of radiographs, including the first image and the second image, wherein each of the plurality of radiographs represents a tooth at a different stage of the nonsurgical root canal treatment, with the first image representing an intact preoperative tooth, the second image representing a tooth after as portion of the nonsurgical root canal treatment has been completed, and a third radiograph of the plurality of radiographs representing a tooth after the nonsurgical root canal treatment has been completed; receive, from the trained machine learning model, a second output indicative of whether the first image and the third radiograph include the same object, wherein the output comprises a first similarity score, and the second output comprises a second similarity score; and determine that the second similarity score satisfies a criterion, wherein the criterion is based on a comparison to a threshold similarity score; and in response to determining that the second similarity satisfies the criterion, indicate that the tooth represented in the first image is different than the tooth represented in the third radiograph, thereby indicating that at least one pair of radiographs in the plurality of radiographs is anomalous.

In some embodiments, the trained machine learning model comprises: a convolutional neural network configured to receive an image as an input, and generate an embedding vector for the received image as an output; a lambda layer configured to determine an L1 distance between the embedding vector and a second embedding vector; and a dense layer configured to generate a similarity score based on the L1 distance between the first embedding vector and the second embedding vector.

In some embodiments, the trained machine learning model comprises: a second convolutional neural network configured to receive an image as an input, and generate the second embedding vector for the received image as an output, wherein the second convolutional neural network is identical to the convolutional neural network.

In some embodiments, the convolutional neural network comprises: a plurality of convolutional layers, including a first convolutional layer and a last convolutional layer; a plurality of batch normalization layers, each of the plurality of batch normalization layers configured to receive, as input, an output of a corresponding convolutional layer of the plurality of convolutional layers, including a first batch normalization layer configured to receive an output of the first convolutional layer and a last batch normalization layer configured to receive an output of the last convolutional layer; a flatten layer configured to receive, as input, an output of the last batch normalization layer; and a dense layer configured to output the embedding vector based on the output of the flatten layer.

In some embodiments, the first image is a radiograph associated with a first subject, and the second image is a radiograph associated with a second subject.

In some embodiments, the output comprises a similarity score, and wherein the one or more hardware processors are further configured to: determine that the similarity score satisfies a criterion, wherein the criterion is based on a comparison to a threshold similarity score; and in response to determining that the similarity score satisfies the criterion, indicate that the first image and the second image include representations of the same object of interest, thereby indicating that the first image and second image are an anomalous pair of radiographs.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for predicting whether a pair of images of a type of object depict the same instance of an object of a particular type of object and presenting information indicative of whether the pair of images are predicted to depict the same object in accordance with some embodiments of the disclosed subject matter.

FIG. 2 shows an example of a system for detecting anomalous pairs of images of an object type in accordance with some embodiments of the disclosed subject matter.

FIG. 3 shows an example of hardware that can be used to implement a radiograph data source, a local computing device, and a remote computing device in accordance with some embodiments of the disclosure.

FIG. 4 shows an example of a flow for training and using mechanisms for detecting anomalous pairs of images of an object type in accordance with some embodiments of the disclosed subject matter.

FIG. 5 shows an example of a process for predicting whether a pair of images of an object type include the same object as a subject in accordance with some embodiments of the disclosed subject matter.

FIG. 6 shows an example of a process for presenting a set of images captured at different times that are each purported to include the same object at the different times with information indicative of whether one or more pairs of the set of images are anomalous in accordance with some embodiments of the disclosed subject matter.

FIG. 7 shows an example of a process for presenting a set of images that are each purported to include a different object with information indicative of whether one or more pairs of the set of images are anomalous in accordance with some embodiments of the disclosed subject matter.

FIG. 8 shows examples of radiographic images from different stages of a nonsurgical root canal treatment procedure performed on a model in accordance with some embodiments of the disclosed subject matter.

FIG. 9 shows examples of a high level architecture of a machine learning model that can be used to predict whether two images depict the same object in accordance with some embodiments of the disclosed subject matter.

FIG. 10 shows an example of an architecture of a convolutional neural network that can be used to implement a machine learning model that can be used to predict whether two images depict the same object in accordance with some embodiments of the disclosed subject matter.

FIG. 11 shows an example of a confusion matric representing performance of an example machine learning model trained to predict whether two radiographic images depict the same tooth in accordance with some embodiments of the disclosed subject matter used to predict whether radiographic images representing different points during a nonsurgical root canal treatment procedure depict the same model tooth, and a table summarizing performance of the model.

FIG. 12 shows a box plot representing distributions of similarity scores generated by the example machine learning model for pairs of radiographic images with for different labels.

FIG. 13 shows a graph showing accuracy of the example machine learning model as a function of similarity score threshold.

FIG. 14 shows example of pairs of consistent and inconsistent radiographic images and a similarity score generated by the example machine learning model based on the content of the two images.

### DETAILED DESCRIPTION

In some embodiments, mechanisms described herein can be used to evaluate materials submitted by a candidate during a practical examination to predict whether the materials submitted by the candidate have characteristics indicative of academic dishonesty in connection with the practical examination.

In some embodiments, mechanisms described herein can use a trained machine learning model that is based on a Siamese Neural Network to detect inconsistencies in radiographic images taken for a root canal treatment (RCT) procedure in a preclinical endodontic course, which can be expected to enhance educational integrity (by increasing the perceived risks associated with academic dishonesty on practical exams, by decreasing the number of students that pass a practical examination through academic dishonesty, etc.).

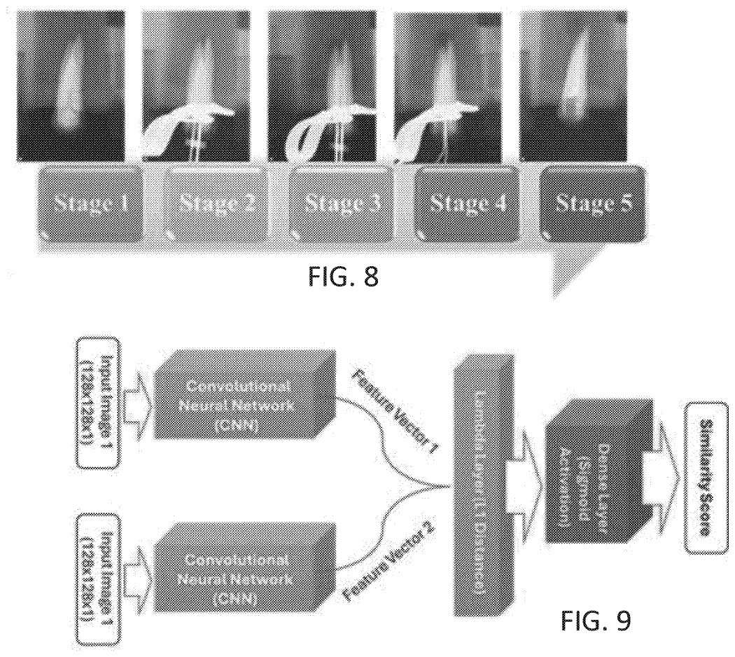

As described below in connection with FIGS. 8 to 13, mechanisms described herein can be implemented using a machine learning model that include a Siamese Neural Network trained to compare radiographs from RCT procedures to predict whether the radiographs are consistent (e.g., the same model is shown in both radiographs) or inconsistent (e.g., the same model is not shown in both radiographs). For example, the machine learning model described in connection with FIGS. 8 to 13 was trained on 3,390 original radiographs, with data augmentation applied to improve generalizability, and the dataset was split into training, validation, and testing subsets. In the example, the data augmentation included dataset expansion, potentially introducing new labeled sets of radiographs that are augmented version of the original radiographs. Performance was evaluated using metrics were calculated that included accuracy, precision, sensitivity (recall), and F1-score. As described below, in connection with FIGS. 8 to 13, a machine learning model implemented and trained using mechanisms described herein achieved an accuracy of 89.31%, precision of 76.82%, sensitivity of 84.82%, and an F1-score of 80.50%, with an optimal similarity threshold identified as 0.48, where maximum accuracy was observed.

In some embodiments, mechanisms described herein can be used effectively detect radiographic inconsistencies in RCT procedures, serving as an objective tool to uphold academic integrity in dental education. Additionally, in some embodiments, using mechanisms described herein can be used to enhance the fairness and reliability of assessments, promote a culture of honesty among students, and reduce the administrative burden on educators. Embracing use of mechanisms described herein in assessment of dental practical examinations aligns with contemporary educational strategies, and can be expected to prepare students for a profession increasingly shaped by digital innovation.

Academic integrity is fundamental in professional education, particularly in dentistry, where ethical conduct is critical for personal growth, patient trust, and public safety. Despite the focus on ethics throughout the curriculum of dental schools, cheating remains a significant and ongoing concern. For example, a paper published in the Journal of Dental Education (Andrews et al., “Faculty and Student Perceptions of Academic Integrity at U.S. and Canadian Dental Schools,” Journal of Dental Education (2007)) describes results of a comprehensive study of 1,153 students and 423 faculty members that uncovered widespread cheating, emphasizing the need for collaboration between administrators and faculty to develop effective strategies to combat dishonest behavior. Similarly, a survey conducted in 1998 (e.g., described in Turner et al., “Enhancing Academic Integrity: Formulating Effective Honor Codes,” Journal of Dental Education (2003)) across all U.S. dental schools revealed an alarming trend, with most institutions encountering one or two cases of academic dishonesty per year. A follow-up study conducted (described in Markman, “Academic integrity in dental school: a call to action,” The Journal of the American College of Dentists (2009) reported a nearly threefold increase in cheating incidents, underscoring the growing severity of the issue.

Historically, the academic community assumed that cheating during practical examinations was relatively unlikely, if not impossible, due to the hands-on nature of these assessments. However, the studies referenced above, and other recent cases, challenge this assumption. One notable study (Bertolami et al., “Why Our Ethics Curricula Don't Work,” Journal of Dental Education (2004)) presented two instances of academic dishonesty during dental practical exams. In a first case, a dental student smuggled a previously prepared plastic tooth into the exam room and substituted it as the assessment tooth. In a second case, a student removed key teeth during the exam to gain better access to the plastic tooth on which the procedure was performed, thereby manipulating the exam conditions. These examples, coupled with the findings from Andrews et al., which reported incidents such as switching prepared teeth or paying others to complete work, illustrate the lengths to which some dental students have gone to succeed dishonestly.

Recently, artificial intelligence (AI) techniques (e.g., including machine learning models that can be trained to perform tasks that are difficult/impossible and/or time consuming for a human expert to perform) have been used to implement tools across various sectors, including education, where its application in detecting and preventing cheating is proving invaluable (e.g., using a tool(s) that utilize AI techniques to inform assessment of work produced by a student). Such tools are likely to become more important as students adopt more sophisticated cheating techniques that are more difficult to discourage and detect using traditional techniques used to enforce academic integrity standards, such as honor codes and manual reviews.

In the context of dental school practical exams, AI techniques can be used to implement analysis tools offer a powerful solution for assisting faculty of the dental school in identifying fraudulent practices that may otherwise go undetected. By leveraging AI (e.g., using mechanisms described herein), dental schools can enhance the accuracy and efficiency of their assessment processes.

In general, AI techniques can be used to implement an AI-based analysis system that can process and analyze relatively large volumes of image data in a relatively short period of time. Additionally, many trained machine learning models can be executed using widely available, and relatively inexpensive compute resources (more computing resources and/or more costly computing resources may be needed to train such machine learning models within a reasonable amount of time). In some embodiments, an AI-based analysis system can be trained to identify inconsistent images in which the inconsistencies are relatively subtle, and that a human reviewer might overlook (especially if the human reviewer is afforded a relatively brief period of time to review the images). For example, in situations where a student attempts to substitute a pre-prepared plastic tooth (e.g., prepared during a simulation lab in preparation for the exam) for the plastic tooth provided to the student for the examination, an AI-based analysis system implemented using mechanisms described herein may detect inconsistency between an image that includes the pre-prepared tooth and an image of the tooth based on subtle differences in various features, such as root canal morphology and apical radiolucency across radiographs submitted by the student as representative of the exam tooth at different stages of the procedure. This can facilitate using such an AI-based analysis system to detect whether each image submitted by a student corresponds to the same tooth, or if the tooth in at least one image is inconsistent, thereby reducing opportunities for successfully cheating.

Additionally, an AI-based analysis system implemented using mechanisms described herein can apply the same level of scrutiny to images submitted by each student, for example, by standardizing and automating the image analysis process, which can mitigate the impact of variations in image quality, radiograph exposure, equipment settings, reviewer fatigue, subjective time pressure felt by a reviewer, etc., that can impact the accuracy of manual review. For example, normalizing such variables via use of an AI-based analysis system can facilitate consistent, objective, and timely evaluations of the radiographs, which can reduce the impact of human error and enhance the overall rigor of the evaluation process, making it more difficult for students to successfully exploit any inconsistencies.

Additionally, as more data is collected (e.g., data from previously undetected instances of cheating and known examples that may appear inconsistent to a human reviewer but are in-fact consistent), an AI-based analysis system can be adapted to incorporate additional information in the new data that was not available when the AI-based analysis system was originally trained. For example, a trained machine learning model (e.g., a convolutional neural network) can be trained further using additional data to determine whether the additional training results in improved performance (e.g., on data from a test data set that is not included in the training data), which can lead to performance improvements over time. As another example, advances in AI technology (e.g., improvements in model architecture, improvements in training algorithms, etc.) can be incorporated into the AI-based analysis system, leading to improvements in performance. In some embodiments, as students develop or adopt more sophisticated cheating techniques (e.g., including tampering with digital images), an AI-based analysis system can be updated (e.g., via re-training, fine tuning, etc.) to detect inconsistencies (e.g., differences at the pixel level) indicative of manipulation that may be imperceptible or impossible for a human reviewer to detect through a visual analysis (e.g., signs of manipulation that are imperceptible to the human eye).

In some embodiments, mechanisms described herein can utilize an AI-based analysis system that includes a Siamese Neural Network to compare images submitted as corresponding to various stages of preclinical endodontic procedures, and determine whether the images are consistent and traceable to the same sample tooth. For example, such an AI-based analysis system can detect attempts by students to submit altered or substituted radiographs, which can facilitate faculty in addressing issues of academic dishonesty in dental practical exams.

In some embodiments, mechanisms described herein can use explainability techniques to provide transparency regarding the basis for classifications generated by the an AI-based analysis system. For example, a Gradient-weighted Class Activation Mapping (Grad-CAM) technique can be used to identify radiographic regions that most influenced the network's output. In some embodiments, bounding boxes can be used (e.g., in addition to, or in lieu of heatmaps), to provide a more structured, interpretable depiction of the model's focal areas. This level of transparency can allow faculty and/or other evaluators to better evaluate the rationale behind each classification. In some embodiments, such visual explanations can improve user understanding and decision-making, for example, by providing numerical or visual explanations (e.g., Grad-CAM bounding boxes, confidence scores, etc.) that can help users interpret results, including results that may otherwise be considered inconclusive.

As described below, an example AI-based analysis system implemented using mechanisms described herein successfully detected pairs of inconsistent radiographs in which there were subtle discrepancies across radiographs, such as changes in root canal morphology or surrounding radiolucency, which may indicate academic fraud by a student. The example AI-based analysis system was trained to analyze pairs of images of teeth to ensure consistency and traceability. When pairs of images identified by the example AI-based analysis system as consistent and inconsistent were analyzed by expert human reviewers, differences indicative of inconsistency were identified when comparing key morphological features between each radiograph. Additionally, the AI-based analysis system was trained to detect potential tampering, such as image manipulation or the substitution of teeth, by the inclusion of training samples that include differences in pixel-level data.

The root canal treatment (RCT) practical exam in preclinical endodontics serves as a critical assessment of dental students' clinical skills, requiring them to perform and document a series of procedural stages on assigned typodont teeth. Mechanisms described herein were used to implement and train an example AI-based analysis system capable of detecting inconsistencies in radiographs submitted at different stages of the RCT procedure for the same tooth, which can buttress the integrity of the assessment process.

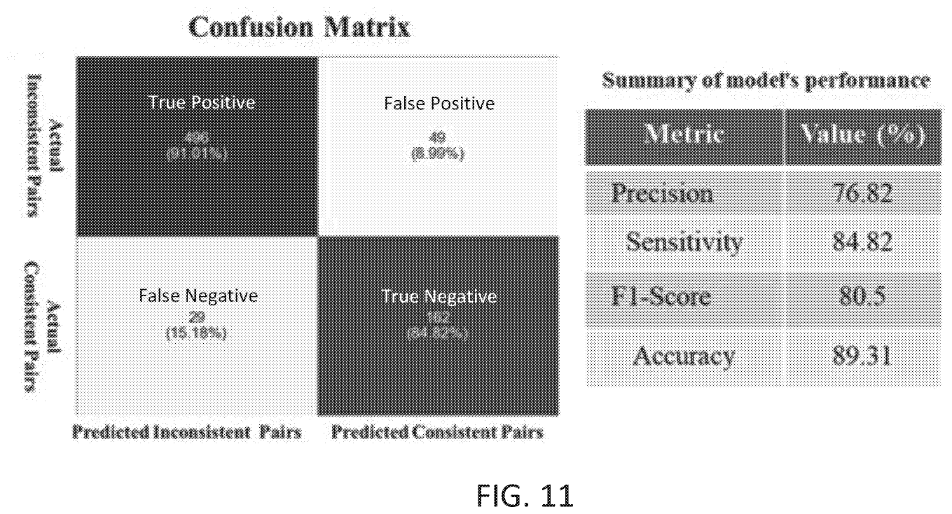

The example AI-based analysis system described below in connection with FIG. 11 was trained using radiographs corresponding to five key points in the RCT procedure, which correspond to five key stages of the treatment that students participating in an example RCT exam are required to capture, including: 1. Preoperative: an initial radiograph of the intact exam tooth before any treatment, which can be captured under the supervision of a proctor to ensure that the student is using the exam tooth provided by the proctor; 2. Working Length Determination: a radiograph captured after the student establishes the working length of the root canal; 3. Master Apical File: a radiograph showing the master apical file at the working length; 4. Master Apical Cone: a radiograph with the master gutta-percha cone fitted to the working length; and 5. Final Obturation: a radiograph captured after the root canal has been filled and the treatment is completed Each stage's radiograph captures unique morphological features, which are likely important for tracking the student's progress in the procedure and verifying the consistency of the tooth being treated. For example, the pre-operative radiograph can serve as a reference point against which subsequent images are compared to detect any discrepancies that might indicate tampering or substitution.

Training data was assembly using radiographs collected from six previous nonsurgical RCT (NSRCT) preclinical competency exams, involving 678 students, to ensure diversity and relevance, resulting in a dataset of 3,390 images. Prior to using the data for training and/or evaluation of an AI-based analysis system, each case was carefully examined to ensure that all radiographs for a given student were consistent and represented legitimate procedural progression without any signs of tampering. This pre-use examination involved visual inspection by experienced endodontists to confirm that the images corresponded to the expected stages of the NSRCT procedure for the same tooth. Morphological features such as tooth shape, root canal configuration, and surrounding landmarks were compared across all stages for the set of radiographs associated with each student to ensure consistency. Any cases with unclear images, suspected inconsistencies, or incomplete radiographic sets were excluded from the dataset used to train and evaluate the example AI-based analysis system to maintain data integrity.

The radiographs used to train and evaluate the example AI-based analysis system were digitized and standardized to maintain uniformity in image dimensions and resolutions. For example, image normalization techniques were applied to adjust for variations in brightness and contrast due to differing exposure settings and equipment, and data augmentation techniques, including random rotations, horizontal and vertical flipping, and scaling, were used, which increases the diversity of the training data, helping the model to better handle real-world variations in radiographic images (e.g., mitigating over-fitting during training).

As described below in connection with FIG. 11, the example AI-based analysis system that was implemented using a Siamese Neural Network model demonstrated high accuracy and robustness in detecting inconsistencies in radiographic images from the NSRCT practical exam. Consistent performance of the example AI-based analysis system was observed across cross-validation folds, and the example AI-based analysis system produced superior results compared to baseline models, which supports the expected effectiveness of AI-based analysis systems implemented using mechanisms described herein when used as a tool for supporting academic integrity in dental education. The ability of the example AI-based analysis system to generalize across different data subsets and maintain stable performance metrics underscores the potential of using mechanisms described herein to implement an AI-based analysis system that can be effectively deployed in educational settings to detect and discourage cheating in practical examinations.

The potential integration of AI into dental education (e.g., using mechanisms described herein) presents a transformative opportunity to enhance the integrity, effectiveness, and educational value of assessment practices. Techniques described in this disclosure, and the results produced by described herein, demonstrate the successful application of a Siamese Neural Network model to detect inconsistencies in radiographic submissions during a nonsurgical root canal treatment (NSRCT) practical exam. In some embodiments, mechanisms described herein can be used in connection with other practical dental procedures beyond NSRCT assessments. For example, an AI-based analysis system implemented using mechanisms described herein can be used to detect inconsistencies in images submitted during practical examinations for cavity preparations, where radiographic or photographic images captured at different stages of the preparation can be analyzed to verify consistency and traceability. As another example, mechanisms described herein can be used in connection with prosthetic fittings, where images of prosthetic components at various stages of fitting and adjustment can be compared to ensure that the same prosthetic and patient anatomy are represented across the submitted images. In some embodiments, mechanisms described herein can be used in other practical medical procedures that involve image-based documentation of procedural stages, such as orthopedic procedures, surgical procedures, and/or other clinical assessments where verifying consistency across a series of images may be beneficial for maintaining assessment integrity.

As described further below, the example AI-based analysis system implemented using the described Siamese Neural Network achieved an accuracy of 89.31%, outperforming the baseline models developed for comparison: a single convolutional neural network (CNN) classifier, which analyzed individual images without pairwise comparison, achieved an accuracy of 75.42%; and a triplet network, an extension of the Siamese architecture processing three images simultaneously, achieved an accuracy of 82.67%. These results suggest that the Siamese Neural Network described herein is effective in tasks requiring the detection of subtle discrepancies between paired images. The superior performance of the Siamese Network can be attributed to its ability to learn relational features between image pairs. By directly comparing radiographs from different stages of the NSRCT procedure, the model effectively captures inconsistencies that may arise from tampering or substitution, an aspect that single-image classifiers may overlook. The network's architecture likely allow it to focus on differences in root canal morphology, anatomical landmarks, and other critical features that indicate whether two images represent the same tooth.

As described above, academic integrity is fundamental to the mission of dental education institutions, as it ensures that graduates possess the requisite knowledge, skills, and ethical standards to provide high-quality patient care. Mechanisms described herein, such as the example AI-based analysis system described below can be used to address a critical gap in ensuring/maintaining integrity during practical exams, a domain traditionally challenging to monitor due to the hands-on nature of assessments. For example, mechanisms described herein can be used to provide an objective mechanism that augments traditional oversight techniques by automating the detection of potential dishonesty, such as radiograph substitution or tampering. Additionally, technological improvements that facilitate more accurate assessment align with the principles of constructivist learning theory, which advocates for authentic assessments that accurately reflect student competencies. Ensuring the validity of assessment outcomes is essential for meaningful learning experiences and reliable evaluations of student performance.

For students, the implementation of AI-driven integrity assurance, such as AI-based analysis systems implemented using mechanisms described herein, can foster a learning environment that emphasizes honesty and accountability. The knowledge that assessments are rigorously monitored may deter dishonest behaviors, and encourage students to engage more deeply with the learning material and develop genuine competence. This aligns with self-determination theory, which highlights the importance of intrinsic motivation and the development of autonomous learners. From an instructional perspective, utilizing an AI-based analysis systems implemented using mechanisms described herein can reduce the administrative burden on faculty, freeing time for more interactive and student-centered teaching approaches. For example, educators can focus on providing formative feedback, facilitating reflective practices, and supporting students in overcoming learning challenges. Additionally, the capacity of AI-based analysis systems implemented using mechanisms described herein to identify inconsistencies can also serve as a diagnostic tool to highlight areas where students may require additional instruction or clarification.

In some embodiments, the use of only high-quality, standardized radiographs in training data may cause variations in image acquisition (e.g., a student that produces poor quality radiographs and/or radiographs that vary significantly in quality) can impact the performance of AI-based analysis systems implemented using mechanisms described herein and the educational validity of assessments based on AI-based analysis systems implemented using mechanisms described herein. For example, it may be important to implement standardized protocols for radiography, and provide students with resources and training on best practices in radiography, to mitigate the potential impact of poor radiograph quality and/or consistency on performance of AI-based analysis systems implemented using mechanisms described herein.

Additionally, transparency regarding the use of an AI-based analysis system can improve the trust of students in the quality and fairness of the assessment, and can potentially decrease dishonest behavior by raising the perceived risk, and correspondingly the potential cost, of cheating. Ethical considerations also demand that students are informed about how their data is used and how an AI-based analysis system contributes to their evaluations. Developing clear policies and communicating them effectively fosters trust and upholds the principles of fairness and respect central to the educational mission.

The use of AI-based tools for monitoring academic integrity raises important ethical considerations. Transparency with students about the use of such technologies is crucial to maintain trust. Institutions should develop clear policies outlining how the AI model is employed, how data is handled, and the procedures following the detection of inconsistencies. This openness ensures that students understand the rationale behind the technology and its role in supporting fair assessment practices. Additionally, positioning an AI-based analysis system as a complement to, rather than a replacement for, the educator's judgment maintains the educator's central role in the assessment process and upholds principles of fairness and due process. Decisions regarding academic misconduct should involve comprehensive reviews, considering any indications of potential academic fraud identified by an AI-based analysis system alongside other evidence.

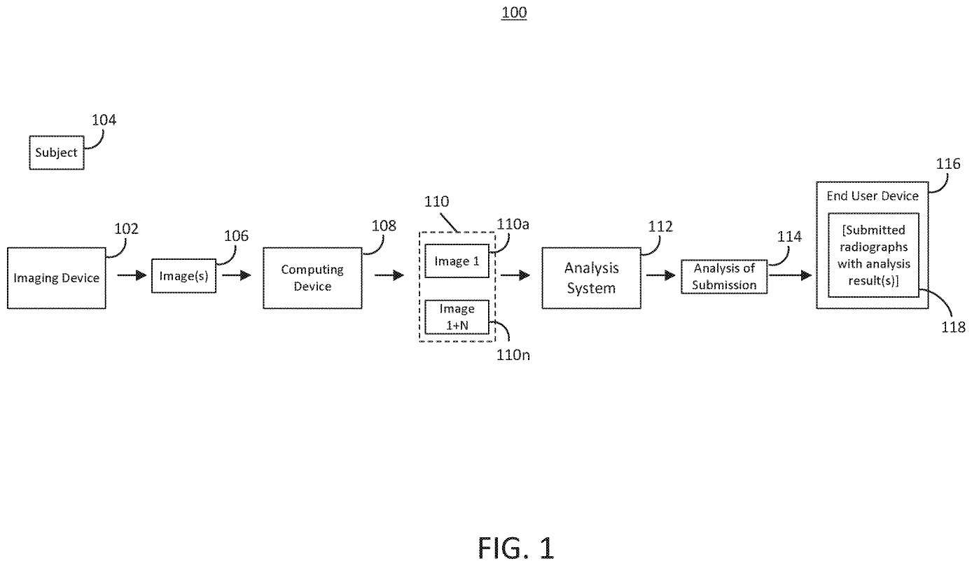

FIG. 1 shows an example of a system 100 for predicting whether a pair of images of a type of object depict the same instance of an object of a particular type of object and presenting information indicative of whether the pair of images are predicted to depict the same object in accordance with some embodiments of the disclosed subject matter. In some embodiments, system 100 can be used in the context of a practical examination used to evaluate whether a candidate (e.g., a student at a professional school, an applicant for professional licensing, etc.) has developed a sufficient level proficiency in a practical skill(s) that is required to be considered competent to practice (e.g., to graduate from the professional school, to be issued a professional license.

In some embodiments, system 100 can include an imaging device 102 used by the candidate to generate an image of a subject 104 (e.g., a model) that the candidate has been instructed to use to demonstrate proficiency in a particular procedure. For example, in the context of a practical examination at a dental school, imaging device 102 can be a radiograph device suitable for generating radiographs of dentition, and subject 104 can be a model that includes an object of interest upon which the procedure is to be performed. In a more particular example, subject 104 can include a model that simulates a portion of a jaw that includes a socket into which a model tooth provided to the candidate can be secured, and a particular model tooth secured within the socket).

In some embodiments, the candidate can be instructed to perform the procedure which is the subject of the practical examination using the model (e.g., including a particular instance of a model object on which the candidate is to perform the procedure), and can be instructed to capture one or more images 106 of the model at predetermined points in the procedure that illustrate whether the candidate has competently performed a particular portion of the procedure. For example, as described below in connection with FIG. 8, a dental student can be provided with a plastic tooth that is to be secured within a model of a jaw, and instructed to capture radiographs of the model tooth at predetermined points in a nonsurgical root canal treatment (NRSCT) procedure performed on the plastic tooth.

In some embodiments, a candidate can be permitted use of imaging device 102 during the examination to capture image(s) 106 of subject 104 at various points during the procedure, which are to be submitted for consideration as part of the evaluation of the candidate's performance on the practical examination. For example, the candidate can: position imaging device 102 and/or subject 104 to capture an image (e.g., a radiograph) having a suitable field of view of a portion of subject 104 on which a portion of the procedure is to be performed and/or has been performed (a plastic tooth and surrounding portions of a jaw model in which the plastic tooth is secured); adjust any settings of imaging device 102 to generate suitable images of subject 104; and cause one or more images of subject 104 to be captured.

In some embodiments, using imaging device to capture image(s) 106 of subject 104 can include using a user interface of imaging device 102 and/or a user interface of a separate computing device (e.g., computing device 108) in communication with imaging device 102. For example, imaging device 102 can include a user interface that can be used to adjust settings and initiate generation of an image (e.g., using knobs, buttons, soft knobs, soft buttons, a graphical user interface, etc.). In such an example, such a user interface can permit a user to login, such that images captured while the user is logged in are automatically associated with the user that is currently logged in. Additionally or alternatively, in such an example, imaging device 102 can include a communication interface (e.g., a port, a connector, a wireless communication system, etc.), such as a USB port, an Ethernet port, a Bluetooth or Wi-Fi communication system, etc., which can be used to connect a device (e.g., a USB connection to a removable storage media such as a flash drive, a wireless connection to a computing device such as a laptop computer, a desktop computer, a smartphone, a tablet computer, a wearable computer, etc.) associated with the candidate to imaging device 102 to (at least temporarily) store image(s) 106.

In some embodiments, a candidate can be instructed to select and submit representative images 110, which each represent a view of subject 104 at a particular point during the procedure. For example, a candidate can use computing device 108 to select, from all images 106 of subject 104, a subset of representative images 110a to 110n to be submitted for use in the evaluation of the candidates procedure. In such an example, computing device 108 can be a computing device used to capture images 106 (e.g., a computing device local to, and associated with, imaging device 102), or another computing device.

In a more particular example, in order for the candidate captures image(s) 106 of subject 104 at a particular point in time during the examination, the candidate can be required to login to imaging device 102 and/or a computing device associated with imaging device 102, and while the candidate is logged in, captured images can be associated with an account used by the candidate to login (e.g., imaging device 102 or associated computing device can cause the images to be recorded at a server in connection with the account used by the candidate). In such an example, the candidate can access the recorded images associated with the account used to login from computing device 108, and can use a user interface presented by computing device 108 to select images to submit from all of the images associated with the account.

As another more particular example, in order for the candidate captures image(s) 106 of subject 104 at a particular point in time during the examination, the candidate can be required to connect a device associated with the candidate to imaging device 102 (e.g., a flash drive, a mobile computing device, etc.), and while the candidate device is connected to imaging device 106, captured images can be stored to the candidate device. In such an example, the candidate can access the recorded images on the candidate device (e.g., by connecting the flash drive to computing device 108, by connecting candidate device to computing device 108, or computing device 108 may be the candidate device to which the images have been stored), and can use a user interface presented by computing device 108 to select images to submit from the images of subject 104 captured using imaging device 102.

In some embodiments, the identity of a candidate that submitted representative images 110 can be protected using any suitable techniques (e.g., the identity of the candidate submitting the images can be encrypted, anonymized, pseudonymized, masked, etc.), to mitigate the potential that the candidate's identity will bias the evaluator.

In some embodiments, after representative images 110 have been selected and submitted by the candidate (e.g., including images 110a to 110n), an analysis system 112 can be used to determine whether there are any anomalous images in representative images 110 using mechanisms described herein. For example, submission of representative images 110 from computing device 108 can cause representative images 110 to be stored using a secure computing device (e.g., using a particular cloud storage location that is not accessible to candidates, within a particular folder in a file system of a server that is not accessible to candidates, etc.). In such an example, analysis system 112 can be permitted to access representative images 110 for each candidate, and analysis system 112 can predict whether any of representative images 110 are anomalous, and/or a user can cause representative images 110 for each candidate to be provided to analysis system 112, and analysis system 112 can predict whether any of representative images 110 are anomalous.

In some embodiments, an analysis 114, generated by analysis system 112, of a set of submitted representative images 110 (e.g., including predictions generated by analysis system 112, and/or information based on the predictions generated by analysis system 112) can be provided to an end user device 116 (e.g., a laptop computer, a desktop computer, a smartphone, a tablet computer, a wearable computer, etc.) that an evaluator uses to facilitate evaluation of a particular candidates performance on the practical examination.

In some embodiments, end user device 116 can cause a user interface 118 that includes at least representative images 110 and information indicative of whether any of the representative images 110 are predicted to be anomalous. For example, an evaluator can use end user device 116 to access representative images 110 via a graphical user interface, and can be presented with any suitable information indicative of whether one or more of representative images 110 has been predicted (e.g., by analysis system 112) to be anomalous. In such an example, raw results of the analysis can be presented (e.g., a similarity score for various pairs of images from representative images 110) and/or a more general indication of whether at least one image is anomalous can be presented (e.g., an average similar score, a lowest similarity score, whether at least one similarity score is below a threshold, etc.).

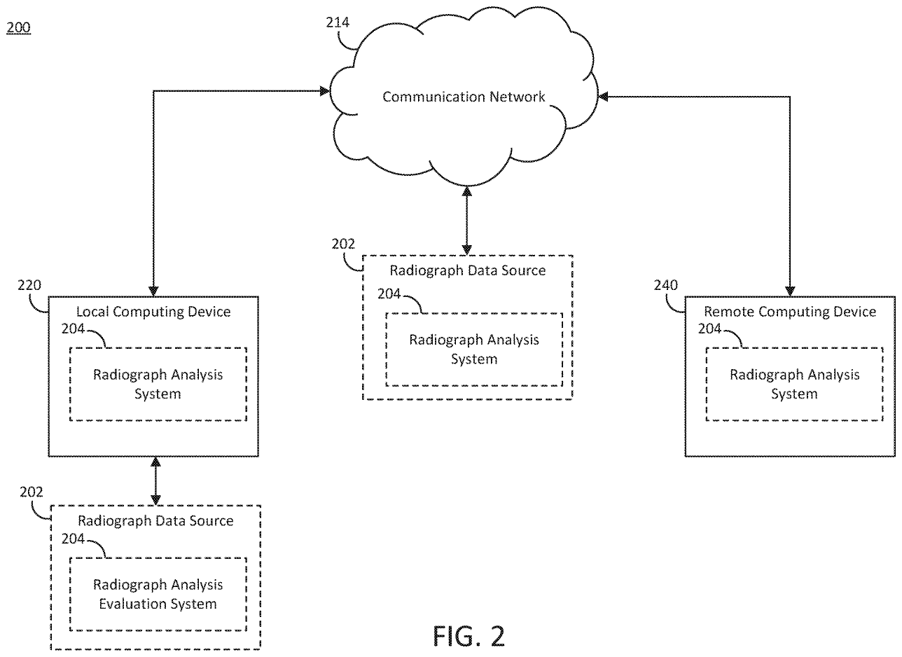

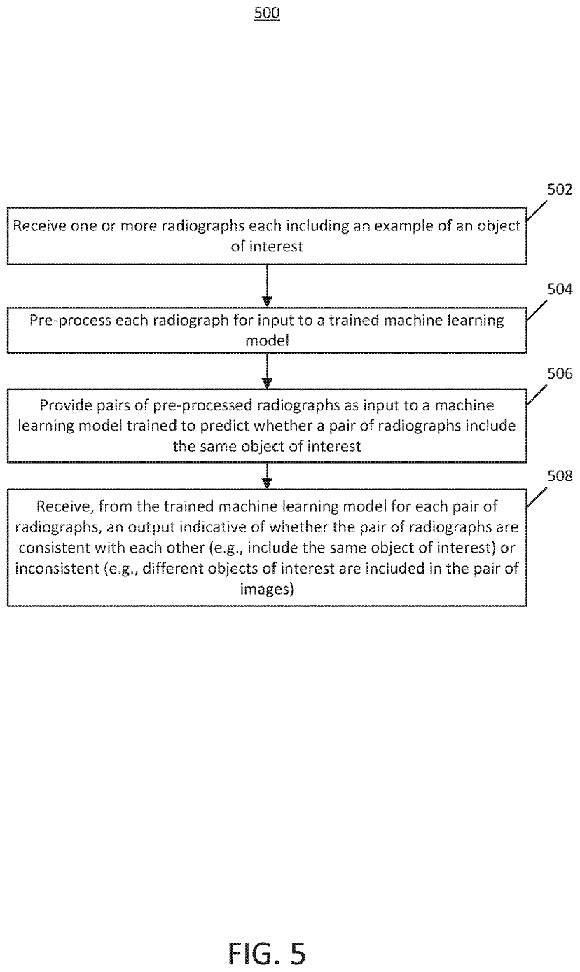

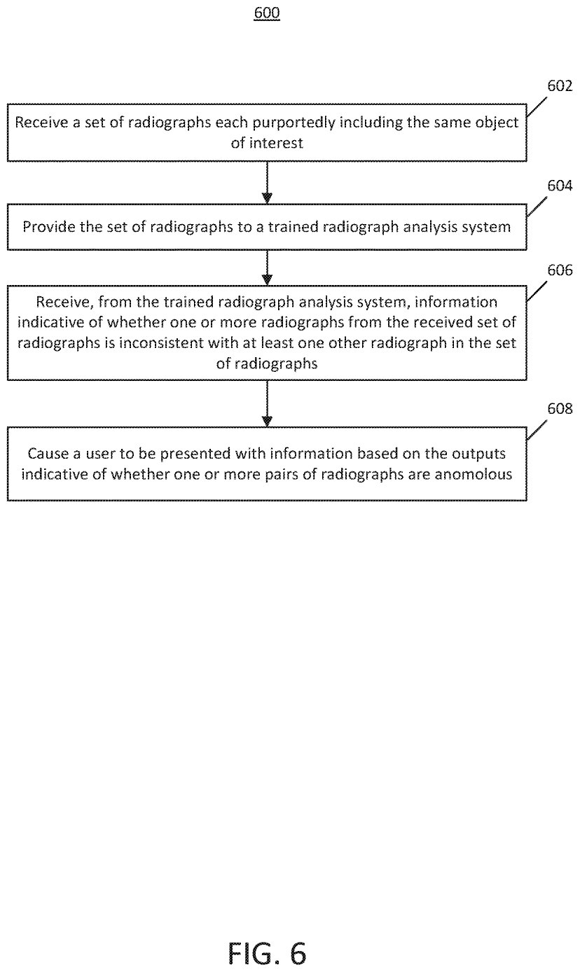

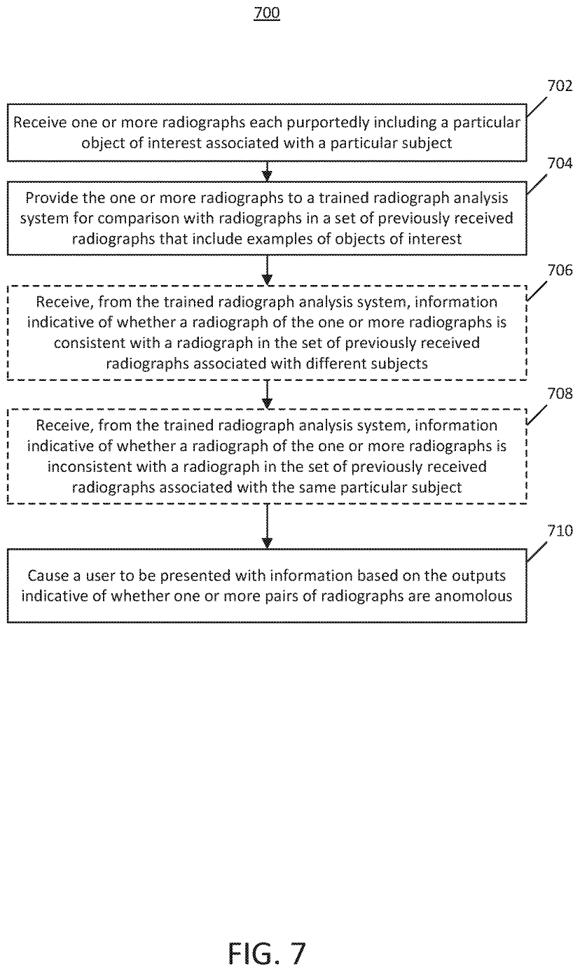

FIG. 2 shows an example of a system 200 for detecting anomalous pairs of images of an object type in accordance with some embodiments of the disclosed subject matter. As shown in FIG. 2, a radiography data source 202 can generate radiography data (e.g., radiographic images) based on characteristics of an object, such as a particular instance of an object of the object type, imaged using a radiography device (e.g., using a sensor(s) of imaging device 102 and/or a computing device that receives data from a sensor(s) of imaging device 102), and can provide the radiograph data (e.g., as raw radiograph data, processed radiograph data, pre-processed radiograph data, etc.) to a local computing device 220 and/or a remote computing device 240 directly and/or indirectly using a communication network 214. In some embodiments, local computing device 220 can execute at least a portion of a radiograph analysis system 204 to identify potentially anomalous pairs of radiographic images (e.g., recorded and/or processed via radiography data source 202). Additionally or alternatively, in some embodiments, radiography data source 202 and/or local computing device 220 can communicate radiograph data (e.g., data generated by radiography data source 202) to a remote computing device 240 over communication network 214, and remote computing device 240 can execute at least a portion of radiograph analysis system 204 to predict whether a pair of radiographic images include the same object (e.g., taken at different times, from different angles, before and after a procedure that is expected to change the appearance of the object, etc.). Additionally or alternatively, in some embodiments, radiography data source 202 can execute at least a portion of radiograph analysis system 204 to predict whether a pair of radiographs include the same instance of an object, and can communicate radiograph data (e.g., raw radiograph data, pre-processed radiograph data, etc.) and/or results (e.g., an indication of whether a pair of images includes the same instance of an object) to local computing device 220 and/or remote computing device 240. In some embodiments, radiograph analysis system 204 can execute one or more portions of process 500 described below in connection with FIG. 5, at least a portion of process 600 described below in connection with FIG. 6, and/or at least a portion of process 700 described below in connection with FIG. 7. For example, radiograph analysis system 204 can be executed by a single computing device (e.g., local computing device 220, remote computing device 240, or radiography data source 202), or can be executed as a distributed system (e.g., a distributed application, a cloud application, etc.) across a combination of computing devices (e.g., by local computing device 220, remote computing device 240, radiography data source 202, and/or any other suitable computing device(s)).

In some embodiments, radiograph analysis system 204 can receive radiograph data (e.g., generated by, and/or received from, radiography data source 202), and can predict whether a pair of radiographs include the same instance of an object based on the radiograph data, either alone, or in combination with any other suitable data from one or more other data sources. For example, local computing device 220 can receive radiograph data from radiography data source 202, and predict a likelihood that a pair of radiographs include the same instance of an object based on the radiograph data. In such an example, local computing device 220 can identify anomalous sets of images (e.g., a pair(s) of images that do not include the same object when the images are expected to include the same object, or a pair(s) of images that do include the same object when the images are not expected to include the same object), present information indicative of whether a particular pair(s) of images both include the same object (e.g., via an output device of local computing device 220, or via another local output device such as end user device 116). Additionally or alternatively, in such an example, local computing device 220 can transmit information indicative of the whether a particular pair(s) of images both include the same object (e.g., via communication network 214) to another device (e.g., remote computing device 240).

As another example, local computing device 220 can receive radiograph data from radiography data source 202, transmit the radiograph data and/or processed radiograph data based on the radiograph data (e.g., pre-processed radiograph data) to remote computing device 240, and remote computing device 240 can predict whether a particular pair(s) of images both include the same object based on the radio graph data. In such an example, remote computing device 240 can present information indicative of whether a particular pair(s) of images both include the same object (e.g., via an output device of remote computing device 240, or via another local output device such as end user device 116). Additionally or alternatively, in such an example, remote computing device 240 can transmit information indicative of whether a particular pair(s) of images both include the same object (e.g., via communication network 214) to another device (e.g., back to local computing device 220, to another remote computing device, etc.).

As yet another example, remote computing device 240 can receive radiograph data from radiography data source 202 (e.g., via communication network 214), and can predict whether a particular pair(s) of images both include the same object based on the radiograph data. In such an example, remote computing device 240 can present information indicative of predict whether a particular pair(s) of images both include the same object (e.g., via an output device of remote computing device 240, or via another local output device such as end user device 216). Additionally or alternatively, in such an example, remote computing device 240 can transmit information indicative of whether a particular pair(s) of images both include the same object (e.g., via communication network 214) to another device (e.g., local computing device 220, another remote computing device, etc.), which can present information indicative of whether a particular pair(s) of images both include the same object (e.g., via an output device of remote computing device 240, or via another local output device such as end user device 116), and/or permit access to the information indicative of whether a particular pair(s) of images both include the same object.

As still another example, radiography data source 202 can predict whether a particular pair(s) of images both include the same object based on the radiograph data. In such an example, radiography data source 202 can provide information indicative of whether a particular pair(s) of images both include the same object to local computing device 220, remote computing device 240, and/or an output device (e.g., end user device 116), which can present the information indicative of whether a particular pair(s) of images both include the same object, and/or permit access to the information indicative of whether a particular pair(s) of images both include the same object.

In some embodiments, local computing device 220 and/or remote computing device 240 can be any suitable computing device or combination of devices, such as a desktop computer, a laptop computer, a smartphone, a tablet computer, a wearable computer, a server computer, a virtual machine being executed by a physical computing device, an embedded controller (e.g., an electronic control unit), a microcontroller, etc. Laptop computers, smartphones, tablet computers, and wearable computers are all examples of mobile computing devices.

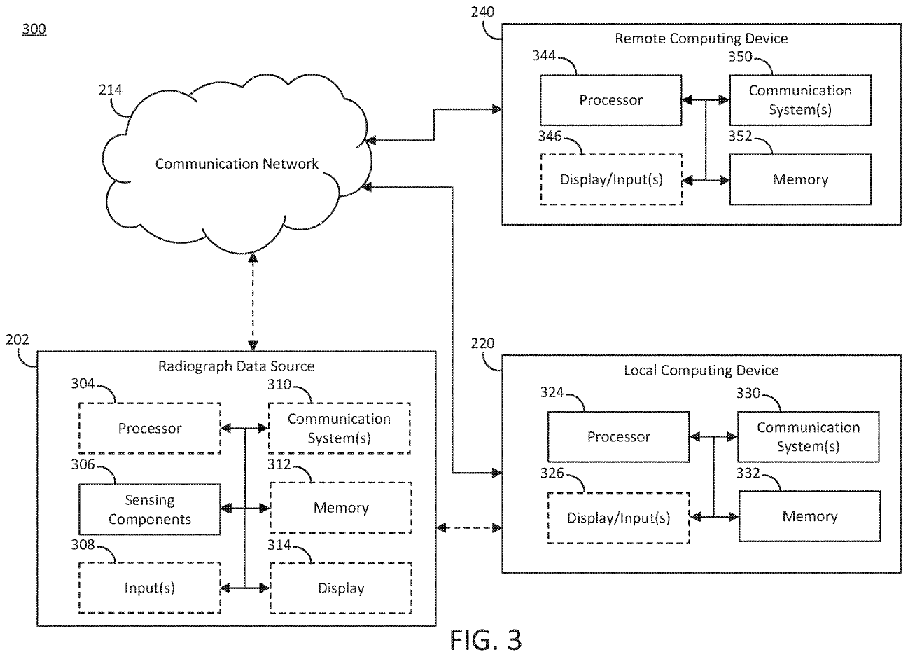

In some embodiments, radiography data source 202 can be any suitable source of radiograph data and/or other data that can be used to identify anomalous pairs of images as described herein. For example, radiography data source 202 can be implemented using one or more radiography sensing components (e.g., as described below in connection with sensing components 306 of FIG. 3) configured to detect an amount of radiation (e.g., at a particular wavelength, at a particular set of wavelengths, within a particular range of wavelengths, etc.) received during an exposure time. In such an example, radiography data source 202 can also be implemented using one or more radiation sources configured to direct radiation (e.g., at a particular wavelength, set of wavelengths, within a particular range of wavelengths, etc.). As another example, radiography data source 202 can be a computing device(s) and/or data storage device(s) used to collect and/or store radiograph data used to identify potentially anomalous pairs of images of a particular type of object (e.g., raw radiograph data, processed radiograph data, etc.), such as a database server(s), or network storage (e.g., a private storage device connected to network 214, a cloud storage device connected to network 214, etc.). Note that although radiography data source 202 is described in connection with providing radiographic data of an object (e.g., one or more radiographic images of the object generated using a radiograph device), radiography data source 202 can also be a source of other data, such as metadata associated with the image (e.g., a time at which the image was generated, an exposure time, identifying information of the device used to capture the image, one or more other settings, etc.), etc.

In some embodiments, radiography data source 202 can be local to local computing device 220 (e.g., physically and logically). For example, radiography data source 202 can be incorporated with local computing device 220 (e.g., radiography data source 202 can be configured as a device or part of a device for capturing, storing, and/or processing radiograph data). As another example, radiography data source 202 can be connected to local computing device 220 by a cable, a direct wireless link, etc. Additionally or alternatively, in some embodiments, radiography data source 202 can be located locally and/or remotely from local computing device 220, and can communicate radiograph data to local computing device 220 (and/or remote computing device 240) via a communication network (e.g., communication network 214).

In some embodiments, communication network 214 can be any suitable communication network or combination of communication networks. For example, communication network 214 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard(s), such as CDMA, GSM, LTE, LTE Advanced, 5G 2R, etc.), a wired network, etc. In some embodiments, communication network 214 can include one or more portions of a local area network (LAN), a wide area network (WAN), a public network (e.g., the Internet, which may be part of a WAN and/or LAN), any other suitable type of network, or any suitable combination of networks. Communications links shown in FIGS. 2 and 3 can each be any suitable communications link or combination of communications links, such as wired links, fiber optic links, Wi-Fi links, Bluetooth links, cellular links, etc.

FIG. 3 shows an example of hardware 300 that can be used to implement a radiography data source 202, a local computing device 220, and a remote computing device 240 of FIG. 2 in accordance with some embodiments of the disclosure. As shown in FIG. 3, in some embodiments, radiography data source 202 can include a processor 304, sensing components 306, one or more inputs 308, one or more communication systems 310, memory 312, and/or a display(s) 314.

In some embodiments, processor 304 can be any suitable hardware processor or combination of processors, such as a central processing unit (CPU), an accelerated processing unit (APU), a graphics processing unit (GPU), a field programmable gate array (FPGA), an application specific integrated circuit (ASIC), a microcontroller, etc.

In some embodiments, sensing components 306 can include components that can be used to generate radiographic data such as image sensing components described above in connection with imaging device 102 of FIG. 1. In some embodiments, sensing components 306 can include active components such as one or more semiconductor-based x-ray detectors, one or more visible spectrum imaging devices, active circuit components (e.g., one or more amplifiers, active filters, analog-to-digital converters, digital signal processors, etc.), etc., and/or can include passive components (e.g., components that do not require an external power source) such as one or more scintillators, passive circuit components (e.g., wires, traces, resistors, capacitors, inductors, etc.), etc. In some embodiments, a radiography sensing component can be a passive or active component, and a signal produced by the radiography sensing component may or may not be conditioned prior to being recorded (e.g., in memory) and/or output (e.g., via communication system 310).

In some embodiments, inputs 308 can include any suitable input devices and/or sensors that can be used to receive user input, such as a keyboard, a mouse, a touchscreen, a touchpad, a microphone, a camera, etc. In some embodiments, display 314 can include any suitable display devices, such as a touchscreen, a computer monitor, a television, etc. In some embodiments, radiography data source 202 can omit sensing components 306, inputs 308, and/or a display(s) 314 (e.g., where radiography data source 202 is not configured for direct user interaction, and/or where radiography data source 202 is a computing device that receives radiography data from a separate radiography device, and is not configured for direct user interaction such as a server of a cloud storage service provider).

In some embodiments, communication system(s) 310 can include any suitable hardware, firmware, and/or software for communicating information over a communication network 214 and/or any other suitable communication networks. For example, communication systems 310 can include one or more transceivers, one or more communication chips and/or chip sets, etc., that can be used to establish a wired and/or wireless communication link. In a more particular example, communication systems 310 can include hardware, firmware, and/or software that can be used to establish a direct or indirect wired connection and/or a direct or indirect wireless connection, such as a wired connection (e.g., an analog connection, a digital connection such as a universal serial bus (USB) connection, a controller area network (CAN) bus connection), a Bluetooth connection, Bluetooth Low Energy connection, an ultrawideband (UWB) connection, a ZigBee connection, a Wi-Fi connection, a cellular connection (e.g., an uplink connection, a downlink connection, or a sidelink connection), an Ethernet connection, etc.

In some embodiments, memory 312 can include any suitable storage device or devices that can be used to store instructions, values, etc., that can be used, for example, by processor 304 to perform processes described herein, to detect and/or record data, to store data, to retrieve data, to transmit data, to analyze data, etc., to communicate with local computing device 220 and/or remote computing device 240 via communication system(s) 310, etc. Memory 312 can include any suitable volatile memory, non-volatile memory, storage, or any suitable combination thereof. For example, memory 312 can include random access memory (RAM), read-only memory (ROM), electronically erasable programmable read-only memory (EEPROM), one or more flash drives, one or more hard disks, one or more solid state drives, one or more optical drives, etc.

In some embodiments, memory 312 can have encoded thereon a computer program for controlling operation of radiography data source 202. In such embodiments, processor 304 can execute at least a portion of the computer program to: record radiographic data in memory 312; process radiographic data; store radiographic data in memory 312; receive input (e.g., via input(s) 308); present a user interface (e.g., via display 314); receive information (e.g., raw radiographic data, processed radiographic data, at least a portion of a user interface, and/or other data) from local computing device 220 and/or remote computing device 240; retrieve radiographic data from storage in memory 312; transmit information (e.g., raw radiographic data, processed radiographic data, outputs from a trained machine learning model, at least a portion of a user interface etc.) to local computing device 220 and/or remote computing device 240; execute at least a portion of a process for detecting anomalous pairs of images of an object, such as one or more portions of processes described below in connection with FIGS. 5, 6, and/or 7, etc.

In some embodiments, local computing device 220 can include a processor 324, a display and/or inputs 326, one or more communication systems 330, and/or memory 332. In some embodiments, processor 324 can be any suitable hardware processor or combination of processors, such as a CPU, an APU, a GPU, an FPGA, an ASIC, a microcontroller, etc.

In some embodiments, display/inputs 326 can include any suitable display devices, such as a computer monitor, a touchscreen, a television, etc., and/or any suitable input devices/sensors that can be used to receive user input, such as a keyboard, a mouse, a touchscreen, a microphone, etc. In some embodiments, local computing system 320 can omit a display and/or inputs (e.g., where local computing system 220 is an embedded device that is not configured for direct user interaction).

In some embodiments, communication systems 330 can include any suitable hardware, firmware, and/or software for communicating information over communication network 214 and/or any other suitable communication networks. For example, communication systems 330 can include one or more transceivers, one or more communication chips and/or chip sets, etc., that can be used to establish a wired and/or wireless communication link. In a more particular example, communication systems 330 can include hardware, firmware, and/or software that can be used to establish a direct or indirect wired connection and/or a direct or indirect wireless connection, such as a wired connection (e.g., an analog connection, a digital connection such as a USB connection, a CAN bus connection), a Bluetooth connection, Bluetooth Low Energy connection, an UWB connection, a ZigBee connection, a Wi-Fi connection, a cellular connection (e.g., an uplink connection, a downlink connection, or a sidelink connection), an Ethernet connection, etc.

In some embodiments, memory 332 can include any suitable storage device or devices that can be used to store instructions, values, etc., that can be used, for example, by processor 324 to perform processes described herein, to receive and/or record data, to store data, to retrieve data, to transmit data, to analyze data, etc., to communicate with radiography data source 202 and/or remote computing device 240 via communication system(s) 330, to receive user input (e.g., via display/inputs 326), to present information and/or a UI to a user (e.g., via display/inputs 326), etc. Memory 332 can include any suitable volatile memory, non-volatile memory, storage, or any suitable combination thereof. For example, memory 332 can include RAM, ROM, EEPROM, one or more flash drives, one or more hard disks, one or more solid state drives, one or more optical drives, etc.

In some embodiments, memory 332 can have encoded thereon a computer program for controlling operation of local computing device 220. In such embodiments, processor 324 can execute at least a portion of the computer program to: receive raw and/or processed radiographic data; record raw and/or processed radiographic data in memory 332; process radiographic data retrieve radiographic data; receive input (e.g., via display/input(s) 326); present a user interface (e.g., via display/input(s) 326); receive information (e.g., raw radiographic data, processed radiographic data, at least a portion of a user interface, and/or other data) from radiographic data source 202, remote computing device 240, and/or another local computing device; transmit information (e.g., raw radiographic data, processed radiographic data, at least a portion of a user interface, outputs from a trained machine learning model, and/or other data) to radiographic data source 202, remote computing device 240, and/or another local computing device; execute at least a portion of a process for detecting anomalous pairs of images of an object, such as one or more portions of processes described below in connection with FIGS. 5, 6, and/or 7, etc.

In some embodiments, remote computing device 240 can include a processor 344, a display and/or input(s) 346, a communication system(s) 350, and/or memory 352. In some embodiments, processor 344 can be any suitable hardware processor or combination of processors, such as a CPU, an APU, a GPU, an FPGA, an ASIC, a microcontroller, etc.

In some embodiments, display/input 346 can include any suitable display devices, such as a computer monitor, a touchscreen, a television, etc., and/or can include any suitable input devices and/or sensors that can be used to receive user input, such as a keyboard, a mouse, a touchscreen, a microphone, etc. In some embodiments, remote computing device 240 can omit display/inputs 346 (e.g., where remote computing device 240 is not configured for direct user interaction, such as if remote computing device 240 is a backend device and/or an embedded device).

In some embodiments, communication systems 350 can include any suitable hardware, firmware, and/or software for communicating information over communication network 214 and/or any other suitable communication networks. For example, communication systems 350 can include one or more transceivers, one or more communication chips and/or chip sets, etc., that can be used to establish a wired and/or wireless communication link. In a more particular example, communication systems 350 can include hardware, firmware, and/or software that can be used to establish a direct or indirect wired connection and/or a direct or indirect wireless connection, such as a CAN bus connection, a Bluetooth connection, Bluetooth Low Energy connection, an UWB connection, a ZigBee connection, a Wi-Fi connection, a cellular connection (e.g., an uplink connection, a downlink connection, or a sidelink connection), an Ethernet connection, etc.

In some embodiments, memory 352 can include any suitable storage device or devices that can be used to store instructions, values, etc., that can be used, for example, by processor 344 to perform processes described herein, to receive and/or record data, to store data, to retrieve data, to transmit data, to analyze data, etc., to communicate with radiography data source 202 and/or local computing device 220 via communication system(s) 350, to receive user input (e.g., via display/inputs 346), to present information and/or a UI to a user (e.g., via display/inputs 346), etc. Memory 352 can include any suitable volatile memory, non-volatile memory, storage, or any suitable combination thereof. For example, memory 352 can include RAM, ROM, EEPROM, one or more flash drives, one or more hard disks, one or more solid state drives, one or more optical drives, etc.

In some embodiments, memory 352 can have encoded thereon a computer program for controlling operation of remote computing device 240. In such embodiments, processor 344 can execute at least a portion of the computer program to: receive raw and/or processed radiographic data; record raw and/or processed radiographic data in memory 352; process radiographic data; receive input (e.g., via display/input(s) 346); present a user interface (e.g., via display/input(s) 346); receive information (e.g., raw radiographic data, processed radiographic data, at least a portion of a user interface, and/or other data) from radiography data source 202, local computing device 220, and/or another remote computing device; retrieve radiograph data from storage in memory 352; transmit information (e.g., raw radiographic data, processed radiographic data, outputs from a trained machine learning model, at least a portion of a user interface etc.) to radiography data source 202, local computing device 220 and/or another remote computing device; execute at least a portion of a process for detecting anomalous pairs of images of an object, such as one or more portions of processes described below in connection with FIGS. 5, 6, and/or 7, etc.

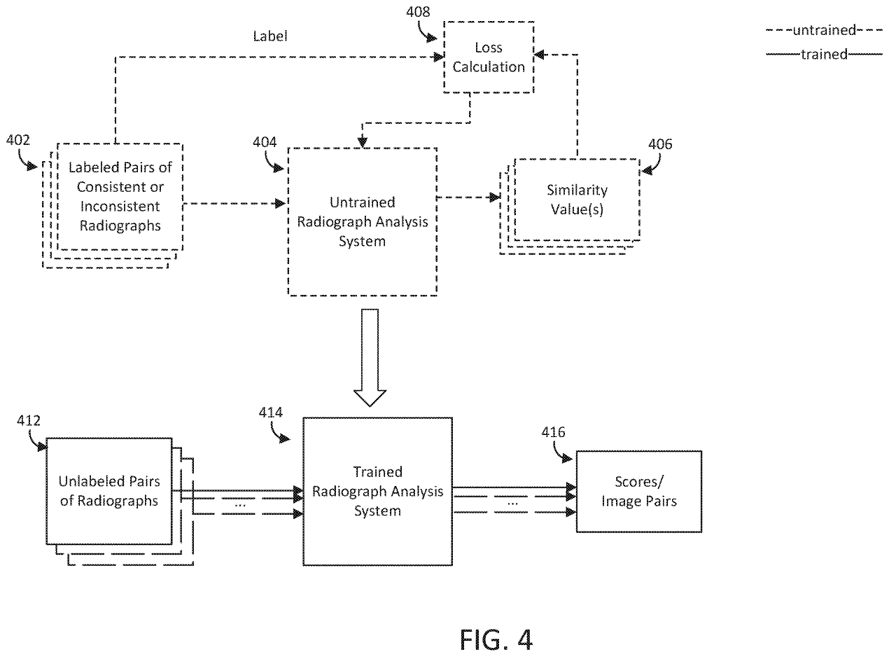

FIG. 4 shows an example of a flow for training and using mechanisms for detecting anomalous pairs of images of an object type in accordance with some embodiments of the disclosed subject matter.

As shown in FIG. 4, labeled pairs of radiographic images 402 that are consistent (e.g., depict examples of the same particular object of a particular type of object) or inconsistent (e.g., depict examples of different objects of a particular type of object) can be used as training data during a training procedure for an untrained radiograph analysis system 404. For example, each labeled pair of radiographs in labeled radiography data 402 can be associated with one or more labels, such as a label indicating whether the same particular object is included in each image of the pair. In such an example, an indication of whether the pair of images are consistent (e.g., include matching objects) or inconsistent (e.g., do not include matching objects) can be used as a label during training to determine performance of untrained radiograph analysis system 404 during training. In some embodiments, when one or more conditions have been satisfied during training (e.g., a predetermined level of performance has been achieved, a predetermined number of training epochs have been completed, performance improvement between training batches and/or epochs has decreased below a predetermined threshold, etc.), training can be considered complete, and untrained radiograph analysis system 404 can be deployed as a trained radiograph analysis system 414. Note that labeled radiography data 402 can include data for one particular type of object, and/or can include data for multiple different types of objects. For example, a machine learning model trained using labeled radiography data 402 can be trained to identify anomalous pairs of radiographs that include objects that are similar to objects in the labeled radiography data 402. In such an example, a machine learning model can be trained to determine a likelihood that an object(s) of interest included in different radiographic images are the same object, regardless of whether other characteristics of the radiographic images are different (e.g., the field of view captured in the image, a location of a region of interest within the image, sharpness, magnification, the presence or absence of other objects, etc.).

In some embodiments, labeled radiography data 402 can be generated using any suitable source of data and/or any suitable technique or combination of techniques. In some embodiments, radiographic images can be captured of various example objects under varying conditions to generate a set of radiographs that include example objects of interest. Images from the set of radiographs can be paired and labeled based on whether the two radiographs are of the same object of interest. In some embodiments, the set of radiographs can include images that were generated for the express purpose of training a radiograph analysis system. Additionally or alternatively, the set of radiographs can include images that were generated for another purpose (e.g., generated during a practical examination for a procedure involving an object of intertest, generated during preparation for such a practical examination, generated as part of a clinical evaluation of a patient, generated during a procedure on a patient, etc.). In some embodiments, one or more data augmentation techniques (e.g., image rotation, horizontal or vertical flipping, scaling, adding noise, adjusting brightness and/or contrast, etc.) can be used to modify radiographic images included in radiography data 402 and/or to generate additional radiographic images that can be included in radiography data 402 (e.g., to facilitate dataset expansion).

In some embodiments, pairs of radiography images can be labeled based on the known subject of the radiograph. For example, images generated under well controlled conditions (e.g., for the express purpose of training, under continuous observation by an expert, etc.) can be associated with information identifying the object(s) in the image, which can be used to determine whether a particular pair of such images are consistent (e.g., depict the same object). As another example, images generated under less well controlled conditions (e.g., during a practical exam with limited proctor supervision) can be associated with information provisionally identifying the object(s) in the image, and the images can be evaluated (e.g., by an expert) to confirm whether the images provisionally identified as being consistent are actually consistent.

In some embodiments, any suitable characteristic(s) of the radiographs and/or objects of interest can vary between different example radiographs that include the same object of interest. For example, as described below, some radiographs generated using a model tooth upon which a procedure is being performed may or may not include equipment used during the procedure. As another example, the size and/or shape of a model tooth upon which a procedure is being performed can vary between radiographs as the procedure is carried out.

In some embodiments, untrained radiograph analysis system 404 can include one or more machine learning models having weights and/or hyperparameters that can be varied during a training process that is used to train the one or more machine learning models to generate outputs indicative of whether a pair of radiographs is anomalous, and trained radiograph analysis system 414 can include one or more machine learning models trained to facilitate identification of anomalous pairs of radiographs, having weights and/or hyperparameters with values that were determined during a training process.

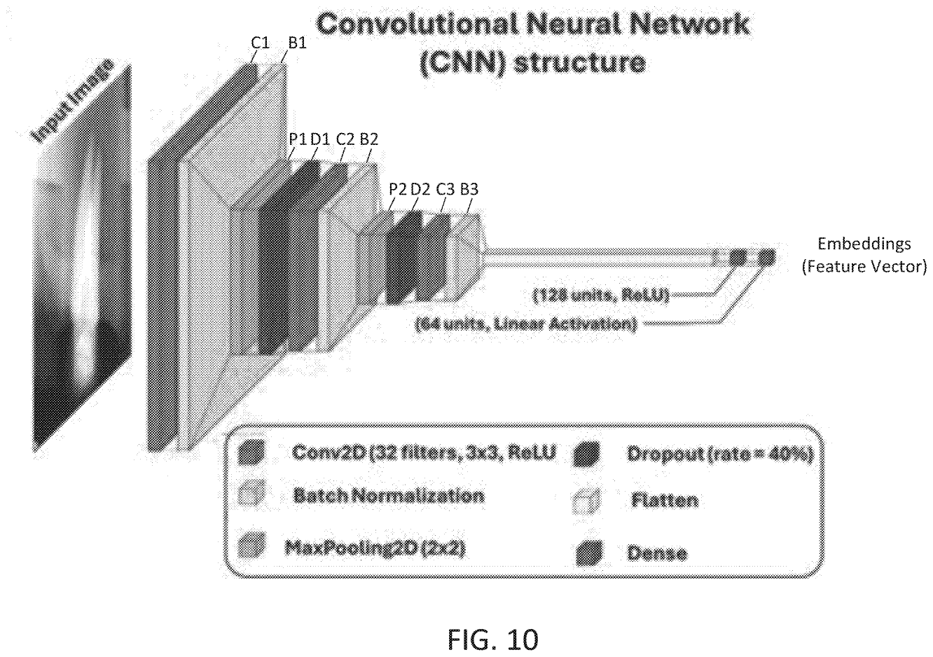

For example, as described below in connection with FIGS. 9 and 10, untrained radiograph analysis system 404 and/or trained radiograph analysis system 414 can include a machine learning model(s) (e.g., a convolutional neural network) that receives a radiographic image(s) as an input, generates a feature vector (e.g., an embedding vector) for the radiographic image(s), and uses the feature vectors generated from a pair of radiographic images to determine whether the radiographs are consistent (e.g., include the same object).

In some embodiments, untrained radiograph analysis system 404 and/or trained radiograph analysis system 414 can be configured to pre-process radiographic image data to generate a suitable input for the machine learning model(s). In such an example, pre-processing can include: increasing or decreasing the dimensions and/or resolution of the image data (e.g., to conform to particular dimensions and/or a particular resolution) using any suitable techniques, such as cropping, padding, downsampling, upsampling, etc.; normalizing the radiograph data to reduce the impact of variations in brightness and/or contrast due to differences cause by exposure settings, differences in equipment, and/or operator skill, etc. Additionally or alternatively, in some embodiments, untrained radiograph analysis system 404 and/or trained radiograph analysis system 414 can be configured to receive pre-processed radiography data (e.g., normalized radiographic image data having particular dimensions) which can be used as input to the machine learning model(s) and/or which can be further processed to be suitable for input to the machine learning model(s).

In some embodiments, the machine learning model(s) included in untrained radiograph analysis system 404 can have any suitable architecture, topology, and/or hyperparameters, and can be trained using any suitable technique or combination of techniques. Additionally, in some embodiments, training of untrained radiograph analysis system 404 can include tuning of any suitable hyperparameters and/or weights associated with the machine learning model(s) included in untrained radiograph analysis system 404.

In some embodiments, during training, untrained radiograph analysis system 404 can generate a similarity value(s) 406 corresponding to pairs of radiographic images in radiography data 402. For example, each similarity value 406 can include a prediction of whether the pair of images is an example of a consistent pair of images or an inconsistent pair of images. In a more particular example, if pairs of consistent radiographs are labeled using a value of 1 and pairs of inconsistent radiographs are labeled using a value of 0, as similarity values approach a value of 1 the similarity value can indicate that untrained radiograph analysis system 404 is more confident that the input is an example of consistent radiographs, and as similarity values approach a value of 0 the similarity value can indicate that untrained radiograph analysis system 404 is more confident that the input is an example of inconsistent radiographs.

In some embodiments, at 408, each value 406 output during training of untrained radiograph analysis system 404 can be used to calculate a value (e.g., a loss value) indicative in how successful untrained radiograph analysis system 404 predicted whether the pairs were consistent or inconsistent, and performance of untrained radiograph analysis system 404 can be evaluated based on the calculated loss values. The performance of untrained radiograph analysis system 404 can be used to tune weights of untrained radiograph analysis system 404 (and/or other values, such as hyperparameters) to improve performance of untrained radiograph analysis system 404 over time (e.g., over multiple batches, epochs, etc.). Additionally, a subset of labeled radiography data 402 can be reserved as test data (e.g., data not used in active training, and used to evaluate performance during training).

In some embodiments, trained radiograph analysis system 414 (e.g., resulting from the training of untrained radiograph analysis system 404) can be used to generate predictions 416 (e.g., similarity scores) indicative of whether an unlabeled pair of radiographs 412 are consistent or inconsistent with each other.

For example, unlabeled radiography data 412 can be radiographic images from a set of radiographs captured at different points during a procedure performed on an object of interest. As a more particular example, unlabeled radiography data 412 can be a pair of images from a set of radiographs submitted by a candidate (e.g., a student, a testee, an applicant, etc.) as part of a practical examination during which the candidate was instructed to perform a dental procedure on a plastic tooth, and take radiographs of the tooth at various during the procedure using a radiograph device (e.g., imaging device 102 used to implement a radiography data source). In such an example, trained radiograph analysis system 414 can generate, for one or more pairs of the images in the set of submitted images, a prediction 416 indicative of whether that pair of images is consistent (e.g., depict the same plastic tooth in a similar setting at different points during the procedure) or inconsistent (e.g., depict different plastic teeth, which may indicate that the candidate significantly changed something about the plastic tooth being imaged and/or about the setting associated with the tooth), which can be used to inform an evaluator (e.g., a professor, a member of a review board, etc.) of whether the set of images includes at least one inconsistent pair of images.

As another example, unlabeled radiography data 412 can be radiographic images identified with different subjects and/or radiographic images identified with the same subject at different points in time. As a more particular example, unlabeled radiography data 412 can include one radiograph submitted by a practitioner (e.g., a practicing dentist, etc.) as part of a pre-approval process for a medical procedure (e.g., a root canal), and another radiograph submitted by the same practitioner or a different practitioner in a different context and/or at a different time. In such an example, the practitioner may be required to submit, to an insurer, one or more radiographs of the insured's tooth on which the procedure is going to be performed that shows indications consistent with damage to the pulp or pulp chamber to be entitled to payment from the insurer.

As a yet more particular example, a practitioner (or someone representing themselves as a practitioner) may falsely submit a radiograph of a first person's tooth showing indications of damage to the pulp with a request for approval to perform a root canal on a different, second person's tooth (e.g., as part of an insurance fraud scheme). In such an example, the same radiograph may be submitted multiple times as allegedly belonging to different people, and/or multiple slightly different radiographs of the same tooth (e.g., captured from slightly different angles, with different settings, etc.) may be submitted as allegedly belonging to different people, and trained radiograph analysis system 414 can generate for one or more pairs of the images received by the insurer, a prediction 416 indicative of whether that pair of images is inconsistent (e.g., depict a different tooth) as expected when comparing radiographs associated with different people, or consistent (e.g., depict the same tooth of the same person), which may indicate that the radiograph was submitted as part an insurance fraud scheme. Additionally or alternatively, in such an example, if radiographs for the second person have previously been submitted (e.g., prophylactic radiographs), trained radiograph analysis system 414 can generate for one or more pairs of the images associated with the insured (e.g., a radiograph submitted as part of the pre-approval process and a radiograph submitted with a claim to insurer requesting payment for dental care involving prophylactic imaging of the insured's teeth), a prediction 416 indicative of whether that pair of images is consistent (e.g., depict the same tooth of the same person) as expected when comparing radiographs that allegedly both depict the teeth of a single person, or is inconsistent (e.g., depict a different tooth) which may indicate that the radiograph was submitted as part an insurance fraud scheme.

In some embodiments, a prediction 416 can be used to generate a user interface and/or report indicating whether an anomalous radiograph has been identified in a set of radiographs (e.g., a radiograph that is inconsistent with another radiograph when consistency is expected, or a radiograph that is consistent with another radiograph when inconsistency is expected), which can be used in an evaluation of a candidate (e.g., to assist an evaluator in identifying cheating), or when attempting to detect insurance fraud.

FIG. 5 shows an example of a process 500 for predicting whether a pair of images of an object type include the same object as a subject in accordance with some embodiments of the disclosed subject matter.

At 502, process 500 can receive one or more radiographs that each includes an example of an object of interest.

In some embodiments, the object of interest can be a model tooth, as described below in connection with FIGS. 8-14.

In some embodiments, process 500 can receive the one or more radiographs from any suitable device, such as a device described above in connection with FIG. 2.

At 504, process 500 can pre-process the one or more radiographs for input to a trained machine learning model for detecting anomalous pairs of images of an object type.

In some embodiments, process 500 can perform any suitable pre-processing to the one or more radiographs, such as pre-processing to ensure that the radiograph(s) is a suitable input to the trained machine learning model (e.g., as described above in connection with FIG. 4).

In some embodiments, process 500 can omit 504 (e.g., if the received radiograph(s) is, as received, suitable input to the trained machine learning model).

At 506, process 500 can provide pairs of pre-processed radiographs as input to a machine learning model trained to predict whether a pair of radiographs include the same object of interest.

In some embodiments, process 500 can provide a pair of radiographs to the trained machine learning model in any suitable format. For example, process 500 can provide each radiograph as an image having particular dimensions and a particular number of color channels (e.g., W×H×C, where W is the width in pixels, H is the height in pixels, and C is the number of color channels). As described below in connection with FIG. 9, each radiograph can be formatted as a 128×128 pixel monochrome image (e.g., with dimensions 128×128×1).

In some embodiments, process 500 can provide an embedded representation of one or both of the radiographs (e.g., an output from a trained convolutional neural network as described below in connection with FIGS. 9 and 10) as input to the trained machine learning model. For example, embeddings generated from a first radiographic image can be saved to memory, and can be provided as input to a trained machine learning model with a second radiographic image to which the first radiographic image is to be compared.

At 508. Process 500 can receive, from the trained machine learning model, for each pair of radiographs, an output indicative of whether the pair of radiographs are consistent with each other, or inconsistent with each other.

In some embodiments, the output can be in any suitable format, such as a value within a range where a first end of the range corresponds to consistency between the radiographs being compared, and the second end of the range corresponds to inconsistency between the radiographs being compared.

FIG. 6 shows an example of a process 600 for presenting a set of images captured at different times that are each purported to include the same object at the different times with information indicative of whether one or more pairs of the set of images are anomalous in accordance with some embodiments of the disclosed subject matter.

At 602, process 600 can receive a set of radiographs that purportedly all include the same object of interest. In some embodiments, process 600 can receive the set of radiographs from a computing device operated by a candidate as a set of radiographs selected to represent an object of interest (e.g., a plastic tooth) at different points in a procedure that the candidate has been instructed to perform as part of an evaluation (e.g., a practical examination, as part of a licensing examination, etc.). For example, the candidate can be provided access to a radiograph device during the procedure, which the candidate can use to capture radiographs of the object of interest at different points during the procedure, and in some cases the candidate may capture multiple radiographs at each of the different points. As a more particular example, if the candidate is unsatisfied with the quality of a particular radiograph, the candidate can capture another after repositioning the object of interest with respect to the field of view of the radiograph device and/or after adjusting one or more settings. As another more particular example, if the candidate is unsatisfied with the quality or completeness of the work performed on the object of interest to that point, the candidate can perform additional work on the object of interest, and capture another radiograph(s) of the object of interest. In such examples, at some point during the evaluation, the candidate can be instructed to select one radiograph to submit for each of various specified points in the procedure (e.g., via a graphical user interface), and the selected radiographs can be submitted for evaluation (e.g., the selected radiographs can be associated with the candidate in a database, file, etc., and can be presented for evaluation via a graphical user interface).

At 604, process 600 can provide the set of radiographs to a trained radiograph analysis system.

In some embodiments, process 600 can provide the set of radiographs to a trained radiograph analysis system (e.g., radiograph analysis system 204), which may or may not be executed by the same computing device that is executing process 600.

In some embodiments, the trained radiograph analysis system can predict, for one or more pairs of the set of radiographs, whether the object of interest in both radiographs of the pair is the same object of interest, or different (e.g., using techniques described above in connection with FIG. 5).

At 606, process 600 can receive, from the trained radiograph analysis system, information indicative of whether one or more radiographs in the received set of radiographs is inconsistent with at least one other radiograph in the set of radiographs.

In some embodiments, the information indicative of whether one or more radiographs in the received set of radiographs is inconsistent with at least one other radiograph in the set of radiographs can include a similarity score output by the trained radiograph analysis system for one or more pairs of radiographs received at 602.

At 608, process 600 can cause a user to be presented with information based on outputs from the trained radiograph analysis system indicative of whether one or more pairs of the radiographs are anomalous. For example, process 600 can cause radiographs from the set of radiographs to be presented via a graphical user interface, and can include any suitable indication of whether at least one radiograph is anomalous based on the information indicative of whether one or more radiographs in the received set of radiographs is inconsistent with at least one other radiograph in the set of radiographs (e.g., based on a similarity score for a particular pair being below a threshold similarity).

In some embodiments, the trained radiograph analysis system can classify pairs of radiographs into three categories: consistent, inconsistent, and inconclusive. For example, pairs with similarity scores that fall within a predetermined range around the threshold similarity score (e.g., within ±1 standard deviation of the threshold) can be classified as inconclusive, indicating that the trained radiograph analysis system refrains from making a definitive recommendation for such pairs. In such embodiments, pairs classified as inconclusive may prompt additional review (e.g., faculty review, expert review, etc.) rather than an automatic determination of consistency or inconsistency. This approach can reduce false positives and ensure that borderline or ambiguous cases receive appropriate human review before any determination is made. In some embodiments, the range defining the inconclusive category can be adjusted (e.g., by an institution, by an administrator, etc.) based on tolerance for false positives or false negatives, which can enhance practical utility of the trained radiograph analysis system in various deployment contexts.

FIG. 7 shows an example of a process for presenting a set of images that are each purported to include a different object with information indicative of whether one or more pairs of the set of images are anomalous in accordance with some embodiments of the disclosed subject matter.

At 702, process 700 can receive one or more radiographs each purportedly include a particular object of interested associated with a particular subject. In some embodiments, process 700 can receive one or more of radiographs from a computing device operated by a provider as a radiograph(s) depicting an object of interest (e.g., a tooth) associated with a particular subject (e.g., dental patient). For example, the provider can transmit (e.g., upload) the radiograph from any suitable source, such as memory of the computing device, from an electronic medical record system, from a picture archiving communication system (PACS), etc., in connection with a submission of a request for prior authorization to perform a procedure on a particular subject (patient), as part of a claim from the provider for a procedure associated with a particular subject (patient).

At 704, process 700 can provide the one or more radiographs to a trained radiograph analysis system for comparison with one or more radiographs in a set of previously received radiographs that include examples of objects of interest. In some embodiments, process 700 can provide a previously received radiograph that includes an example(s) of an object of interest as input to the trained radiograph analysis system together with a radiograph received at 702. Additionally or alternatively, in some embodiments, process 700 can provide a radiograph received at 702 as input to the trained radiograph analysis system, and a feature vector (e.g., an embedding vector) that was previously generated by the trained radiograph analysis system based on a previously received radiograph. For example, a radiograph can be provided as input to a trained convolutional neural network (e.g., a CNN with an architecture similar to the CNN described below in connection with FIG. 10), and can receive an embedding vector output by the trained CNN. In such an example, the received embedding vector can be stored (e.g., in connection with information that can be used to associated the embedding vector with a particular radiograph), such that the stored embedding vector can be provided as an input to the trained radiograph analysis system (e.g., which can generate an embedding vector for a radiograph received at 702 for comparison with the stored embedding vector).

In some embodiments, process 700 can provide the received radiograph(s) to a trained radiograph analysis system (e.g., radiograph analysis system 204), which may or may not be executed by the same computing device that is executing process 700.

At 706, process 700 can receive, from the trained radiograph analysis system, information indicative of whether a radiograph of the one or more radiographs is consistent with a radiograph in a set of previously received radiographs associated with different subjects.

In some embodiments, the trained radiograph analysis system can predict, for the radiograph(s) received at 702, whether the object of interest in the radiograph(s) is the same as an object of interest in a previously received radiograph that is associated with a different subject. For example, the trained radiograph analysis system can compare the radiograph(s) to radiographs submitted in connection with other subjects (e.g., other people insured by an insurer, radiographs submitted by the provider for other patients, etc.).

In some embodiments, the information indicative of whether one or more radiographs in the received set of radiographs is consistent with at least one other radiograph in the set of previously received radiographs can include a similarity score output by the trained radiograph analysis system for one or more pairs of radiographs received at 702.

In some embodiments, process 700 can omit 706.

At 708, process 700 can receive, from the trained radiograph analysis system, information indicative of whether a radiograph of the one or more radiographs is inconsistent with a radiograph in the set of previously received radiographs associated with the same particular subject.

In some embodiments, the trained radiograph analysis system can predict, for the radiograph(s) received at 702, whether the object of interest in the radiograph(s) is the same as an object of interest in a previously received radiograph that is associated with the same subject. For example, the trained radiograph analysis system can compare the radiograph(s) to radiographs previously submitted in connection with the same subject (e.g., in connection with a previous request for prior authorization, in connection with a previous claim, etc.).

In some embodiments, the information indicative of whether one or more radiographs in the received set of radiographs is inconsistent with at least one other radiograph in the set of previously received radiographs can include a similarity score output by the trained radiograph analysis system for one or more pairs of radiographs received at 702.

In some embodiments, process 700 can omit 706.

At 710, process 700 can cause a user to be presented with information based on outputs from the trained radiograph analysis system indicative of whether one or more pairs of analyzed radiographs are anomalous. For example, process 700 can cause the radiograph(s) received at 702 to be presented via a graphical user interface, and can include any suitable indication of whether at least one radiograph is anomalous based on received at 706 and/or 708.

FIG. 8 shows examples of radiographic images from different stages of a nonsurgical root canal treatment procedure performed on a model in accordance with some embodiments of the disclosed subject matter. In particular, FIG. 8 shows representative radiographic images from different stages of the nonsurgical root canal treatment (NSRCT) procedure, illustrating the progression of treatment steps.

In FIG. 8, “Stage 1” is an initial radiograph (e.g., a preoperative radiograph) of the intact tooth before any treatment, “Stage 2” is a radiograph (e.g., a working length radiograph) showing that the working length has been successfully determined, “Stage 3” is a radiograph (e.g., a master apical file radiograph) showing the master apical file at the working length, “Stage 4” is a radiograph (e.g., a master apical cone radiograph) showing that the master gutta-percha cone fitted to the working length, and “Stage 5” is a radiograph (e.g., a final obturation radiograph) showing that tooth after the root canal has been filed and treatment is completed.

FIG. 9 shows examples of a high level architecture of a machine learning model that can be used to predict whether two images depict the same object in accordance with some embodiments of the disclosed subject matter. As shown in FIG. 9, a Siamese Neural Network architecture designed for comparing pairs of input radiographs can include two identical Convolutional Neural Networks (CNNs) that extract features from each radiograph (e.g., embeddings output from each CNN), a Lambda layer that calculates the L1 distance between the feature sets, and a dense layer with sigmoid activation that generates a similarity score based on the output of the Lambda layer.

In the example architecture of FIG. 9, the Siamese Network includes two identical CNNs that share weights and parameters. This design ensures consistent feature extraction from both input images, allowing for a direct comparison of their characteristics. As described below in connection with FIG. 10, each CNN can be implemented using multiple convolutional layers with Rectified Linear Unit (ReLU) activation functions, which can extract hierarchical features (e.g., corresponding to root canal morphology and apical structures). Max-pooling layers can be included in each CNN, which can reduce the spatial dimensions of the feature maps, retaining essential information while preventing overfitting. The extracted features can be flattened (e.g., using a flatten layer of each CNN) and passed through fully connected layers to produce compact embedding vectors for each image.

In some embodiments, training data for a Siamese Neural Network can involve creating labeled pairs of images (e.g., matching, consistent, or positive pairs and non-matching, inconsistent, or negative pairs) to provide the Siamese Neural Network with examples that can be used to learn weights that successfully distinguish between matching and non-matching pairs.

For example, to generate training data used to train the example AI-based analysis system that produced results described in connection with FIGS. 11-13, consistent (e.g., matching) and inconsistent (e.g., non-matching) example pairs of radiographs were generated. In a particular example, from the set of radiographs associated with each student, the preoperative radiograph (e.g., stage 1) was used as a common reference image, and was paired with the radiograph in the set corresponding to each subsequent procedural radiograph (e.g., stages 2 to 5), resulting in four pairs of matching radiographs for each complete set of radiographs. These pairs were used to represent consistent images of the same tooth at different stages, serving as examples that can be used to train and/or evaluate an AI-based analysis system for predicting whether a pair of images depicting a common type of object (e.g., a tooth) depict the same instance of that type of object.

As another more particular example, from the set of radiographs associated with each student, the preoperative radiograph (e.g., stage 1) was used as a common reference image, and was paired with radiographs in sets corresponding to each subsequent procedural radiograph (e.g., stages 2 to 5) from different students, resulting in four pairs of non-matching radiographs for each complete set of radiographs. These pairs were used to represent inconsistent images of different teeth at different stages, serving as examples that can be used to train and/or evaluate an AI-based analysis system for predicting whether a pair of images depicting a common type of object (e.g., a tooth) do not depict the same instance of that type of object.

This pairing strategy can help facilitate the model learning to recognize both genuine procedural progressions and discrepancies that may indicate substitution or tampering.

After obtaining the embedding vectors from both images, the L1 distance (sometimes referred to as Manhattan or taxicab distance) between the embeddings was calculated to quantify similarity between the images based on the embeddings produced by the CNN. For example, each embedding output from the CNN was treated as an N-dimensional vector (e.g., a first N-dimensional vector V1 generated from the first image, and a second N-dimensional vector V2 generated from the second image), and the L1 distance

$$( e . g . , {\sum }_{i = 1}^{N} \vert V {1}_{i} - V {2}_{i} \vert )$$

was calculated between the vectors. A smaller distance indicates higher similarity, suggesting that the radiographs are more likely to represent the same tooth at different procedural stages. A predefined threshold was determined empirically to classify pairs as consistent or inconsistent.

A custom data generator was implemented to efficiently create and feed image pairs into the model during training. The generator ensured a balanced representation of matching and non-matching pairs in each batch.

The training process used to generate a trained model involved using a combination of loss function, optimizer, learning rate, batch size, number of epochs, and early stopping criteria. For example, a contrastive loss function was employed to train AI-based analysis systems implemented using a Siamese Neural Network architecture. This function encourages the model to output embeddings that are close together for matching pairs and far apart for non-matching pairs.

As another example, the Adam optimizer was used during training of AI-based analysis systems implemented using a Siamese Neural Network architecture, for its adaptive learning rate capabilities. An initial learning rate was used at the beginning of training, and was reduced when the validation loss plateaued.

As yet another example, the batch size and number of epochs were determined empirically through experimentation, with a goal of balancing computational resources and model performance.

As still another example, training was monitored to prevent overfitting. If the validation loss did not improve over a set number of epochs, training was halted.

Hyperparameter tuning was conducted to optimize performance of the machine learning model. Both grid search and random search techniques were used to fine-tune parameters such as the number of convolutional layers, filter sizes, learning rate adjustments, and dropout rates. Dropout layers were included to prevent overfitting by randomly disabling neurons during training.

A k-fold cross-validation approach was employed to assess the model's robustness across different data partitions. Alternative models, including single CNNs and different neural network architectures, were also trained and evaluated for comparison. The example AI-based analysis system implemented using a Siamese Neural Network architecture consistently outperformed the baselines alternative models in detecting radiograph inconsistencies.

Several metrics can be used to assess model performance, which can include metrics based on the number of true positives (e.g., correctly identified inconsistent pairs), false positives (e.g., consistent pairs identified incorrectly as inconsistent pairs), true negatives (e.g., correctly identified consistent pairs), and false negatives (e.g., consistent pairs identified incorrectly as inconsistent pairs) identified by the trained AI-based analysis system. For example, performance metrics can include: accuracy, which can be calculated as the proportion of correctly classified radiograph pairs out of all pairs evaluated; precision, which can be calculated as the ratio of true positives (correctly identified inconsistent pairs) to all predicted positives; recall (sometimes referred to as sensitivity), which can be calculated as the ratio of true positives to all actual positives; and/or F1-Score, which can be calculated as the harmonic mean of precision and recall. These metrics can provide a relatively comprehensive evaluation of a trained model's ability to correctly identify consistent and inconsistent radiograph pairs.

FIG. 10 shows an example of an architecture of a convolutional neural network that can be used to implement a machine learning model that can be used to predict whether two images depict the same object in accordance with some embodiments of the disclosed subject matter. As shown in FIG. 10, an example convolutional neural network (CNN) used to implement a Siamese Network as described herein can be configured to receive a radiographic image as input, and generate embeddings using various layers and activation functions to process the radiographic images. In general, the architecture of FIG. 10 can include multiple convolution layers with a non-linear activation function (e.g., a rectified linear unit (ReLU) activation function), with each convolution layer being followed by a batch normalization layer (B), and all but the final batch normalization layer followed by a max pooling layer (P) and a dropout layer (D), with the final batch normalization being followed by a flatten layer that converts the output of the final batch normalization layer to a one dimensional array. The one dimensional array output by the flatten layer can be input to an activation layer(s) (e.g., a non-linear activation layer, followed by a linear activation layer in FIG. 10), with the output from the activation layer(s) being an embedding vector corresponding to the input radiographic image.

The example architecture of FIG. 10 is based on hyperparameter tuning that led to hyperparameters that provided a balance between model complexity and generalization performance. In the example of FIG. 10, the CNN includes three convolutional layers (C1 to C3) with 32, 64 and 128 respectively, that each used a kernel size of 3×3×1, the learning rate was set at 0.0001, and a batch size of 32 was found to be optimal. In some embodiments, the CNN can include four convolutional layers with 32 to 128 filters. A dropout rate of 0.5 was applied during training to prevent overfitting by randomly disabling neurons during training. The output of the third convolutional layer of the CNN is input to a batch normalization layer, and flattened (e.g., using the flatten layer shown in FIG. 10). The flattened output is processed by a dense layer with 128 units and ReLU activation, and then processed by a final dense layer with 64 units and linear activation, which outputs the embeddings that can be used as feature vectors (e.g., as described above in connection with FIG. 9).

FIG. 11 shows an example of a confusion matric representing performance of an example machine learning model trained to predict whether two radiographic images depict the same tooth in accordance with some embodiments of the disclosed subject matter used to predict whether radiographic images representing different points during a nonsurgical root canal treatment procedure depict the same model tooth, and a table summarizing performance of the model.

The results in FIG. 11 are based on a study conducted in accordance with Marquette University ethics committee and approved IRB parameters and the principles of the Declaration of Helsinki, using the example AI-based analysis system described above in connection with FIGS. 9 and 10. All radiographic data was anonymized to protect student identities and ensure confidentiality. Used in an academic setting, output(s) of an AI-based analysis system implemented in accordance with mechanisms described herein can be used to support academic integrity by identifying potential inconsistencies that may warrant further investigation. Any detected discrepancies can be subject to additional human review to confirm findings and provide due process.

The results shown in FIG. 10 demonstrate the successful application of an AI-based analysis system implemented using a Siamese Neural Network model to detect inconsistencies in radiographic submissions during the nonsurgical root canal treatment (NSRCT) practical exam. By achieving high accuracy in distinguishing between consistent and inconsistent radiograph pairs, the AI-based analysis system provides an objective tool to support academic integrity in dental education. Implementing and using an AI-based analysis system in accordance with mechanisms described herein can be expected to provide significant educational benefits, such as fostering a culture of honesty among students (e.g., by increasing the chances of cheating being detected), reducing the administrative burden on faculty, and integrates technology-enhanced learning into the curriculum.

The example AI-based analysis system implemented using a Siamese Neural Network was evaluated using a test dataset (a portion of image pairs set aside from the original dataset, and not used during training) to assess the effectiveness of the example AI-based analysis system in detecting inconsistencies in radiographic image pairs submitted during the NSRCT preclinical endodontics competency exam.

As shown in FIG. 11, example AI-based analysis system achieved an overall accuracy of 89.31% on the test set. The precision was 76.82%, indicating that out of all the pairs the model predicted as inconsistent, 76.82% were correctly identified. The sensitivity (recall) was 84.82%, showing that the model correctly identified 84.82% of all actual inconsistent pairs. The F1-score, was 80.50%, reflecting a balanced performance between precision and recall.

These metrics are summarized in the confusion matrix in FIG. 11, which illustrates the example AI-based analysis system performance on the test data, providing a detailed breakdown of true positives, true negatives, false positives, and false negatives. This comprehensive overview allows for an in-depth understanding of the example AI-based analysis system classification capabilities and areas where misclassifications occurred.

To assess the example AI-based analysis system generalizability, a 5-fold cross-validation was performed. The example AI-based analysis system consistently demonstrated high performance across all folds, with a mean accuracy of 89.31% and a standard deviation of 1.95%. The low standard deviation indicates that the performance is relatively stable across different subsets of the data, confirming the reliability and robustness of the example AI-based analysis system.

Alternative models were developed for comparison to validate the effectiveness of the example AI-based analysis system implemented using the Siamese Neural Network architecture. A (single) CNN classifier was trained to classify individual images achieved an accuracy of 75.42%, significantly lower than that of the example AI-based analysis system implemented using the Siamese Neural Network. The single CNN was used to extract a feature embedding for each image, and the distance between the feature embeddings of images from a set of images was calculated (e.g., based on the L1 distance as described above in connection with FIG. 9). If the similarity is below a threshold, the image is classified as inconsistent. Unlike the CNN in the example AI-based analysis system, the single CNN classifier was not trained using pairs of images labeled consistent or inconsistent to indicate whether they both include the same object, which likely led to the embeddings generated using the single CNN classifier to be less suited to use for determining whether a pair of images includes the same object. Another model, a triplet network that used embeddings for three images, achieved an accuracy of 82.67%, still below the performance of the example AI-based analysis system implemented using the Siamese Neural Network. Training of the triplet network included providing sets of three images (e.g., an anchor image such as the Stage 1 image in FIG. 8, a matching example such as one Stage 2 through Stage 5 in FIG. 8, and a non-matching example such as an image from another set of radiographs) to the same CNN with shared weights (e.g., rather than providing a pair of matching or non-matching images to the same CNN with shared weights as described above in connection with FIG. 9). The CNN of the triplet network was trained using a loss function that incorporated components corresponding to both the distance between the anchor and the matching image (e.g., a first L1 distance, L1_{c}), as well as the distance between the anchor and the non-matching image (e.g., a second L1 distance, L1ᵢ), to attempt to train the CNN to learn an embedding space that is well suited to determine whether or not a pair of images includes the same object by minimize the distance between the matching pair and maximize the distance between the non-matching pair (e.g., to increase L1_{c} relative to L1ᵢ). These comparisons underscore the superior performance of using mechanisms described herein, for example including a Siamese Neural Network, for the task of radiograph pair comparison in detecting inconsistencies.

In some embodiments, alternative neural network architectures may be used to implement an AI-based analysis system for detecting radiograph inconsistencies. For example, a Vision Transformer (ViT)-based Siamese architecture was also evaluated, which achieved approximately 84.5% accuracy. The lower performance of the ViT-based architecture compared to the CNN-based Siamese Neural Network was likely due to limitations in dataset size and the computational resources available for training. In some embodiments, future implementations of mechanisms described herein involving larger, more diverse datasets may benefit from attention-based architectures, such as ViT-based models, which may provide improved performance when sufficient training data and computational resources are available.

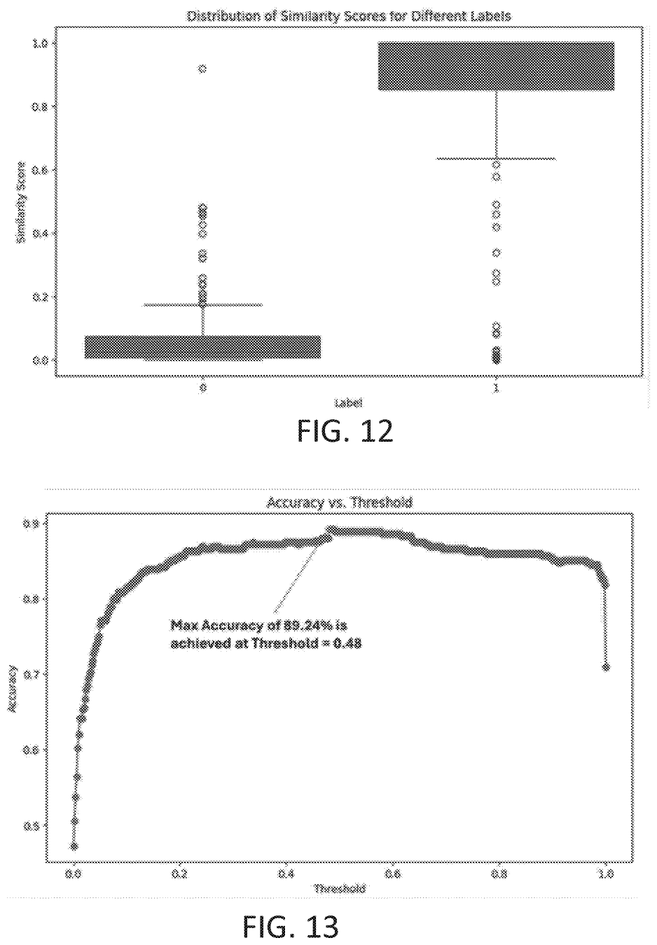

FIG. 12 shows a box plot representing distributions of similarity scores generated by the example machine learning model for pairs of radiographic images with for different labels. In the box plot of FIG. 12, label ‘1’ denotes consistent pairs of radiographs and label ‘0’ denotes inconsistent pairs, highlighting the capacity of the example AI-based analysis system to distinguish between these categories. As shown in FIG. 12, the consistent pairs tended to produce lower distance scores (indicating higher similarity), while inconsistent pairs tended to produce higher distance scores, demonstrating a clear separation between the two classes.

FIG. 13 shows a graph showing accuracy of the example machine learning model as a function of similarity score threshold. As shown in FIG. 13, the accuracy is relatively stable between thresholds of about 0.2 and about 0.9, with a marked point indicating the threshold at which maximum accuracy is achieved. Determining the optimal similarity score threshold can help maximize the model's accuracy. As shown in FIG. 13, the threshold at which maximum accuracy of 89.24% was achieved at a threshold of 0.48. This threshold was used to classify radiograph pairs as consistent or inconsistent during the evaluation that produced the results summarized in FIGS. 11 and 12, balancing the trade-off between precision and sensitivity.

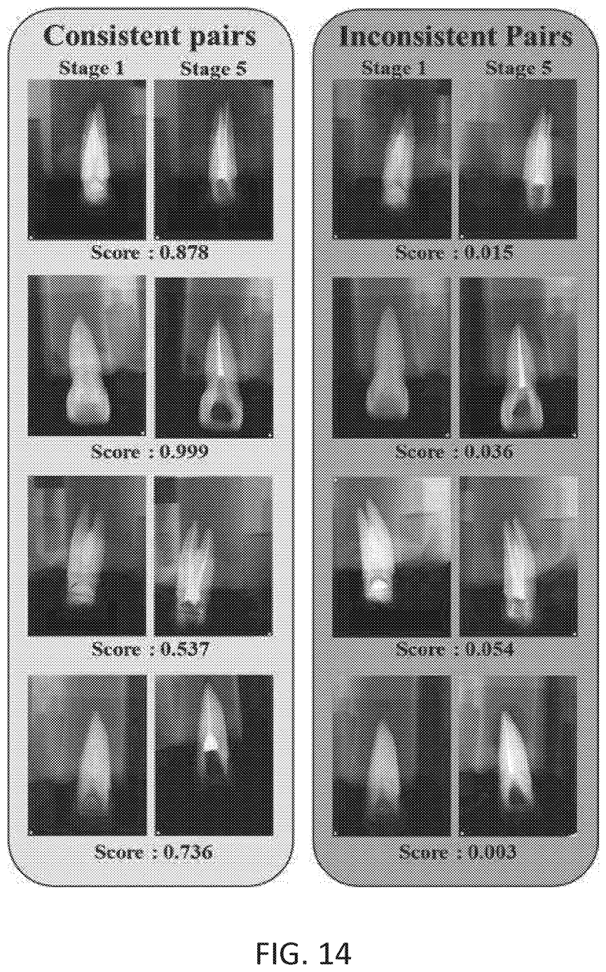

FIG. 14 shows examples of pairs of consistent and inconsistent radiographic images and a similarity score generated by the example machine learning model based on the content of the two images. The left panel shows examples of consistent pairs (Stage 1 and Stage 5) with high similarity scores, indicating radiographs from the same case across treatment stages, and the right panel presents inconsistent pairs with low similarity scores, representing radiographs from different cases. These examples illustrate the ability of the example AI-based analysis system to successfully differentiate between consistent and inconsistent pairs based on similarity scoring.

Several case studies were examined, including the cases shown in FIG. 14, to illustrate the performance of the example AI-based analysis system in practical scenarios. In a simulated instance where a student's procedural radiographs were intentionally replaced with images from another tooth, the example AI-based analysis system successfully identified the inconsistency, demonstrating its practical utility in detecting potential academic dishonesty. In another case, the model incorrectly flagged a consistent pair as inconsistent due to minor variations in image orientation and exposure. This highlights the importance of image standardization and suggests potential areas for model improvement, such as incorporating image alignment techniques into pre-processing and/or enhancing the robustness to variations in exposure (e.g., via inclusion of additional data in the training data representing variations in orientation and/or exposure).

An AI-based analysis system implemented using mechanisms described herein was evaluated using an educator survey methodology to assess practical impact on detection accuracy. In an evaluation conducted during a mock exam, dental educators were asked to participate in two exam conditions: a first exam condition in which educators independently grade radiograph pairs without AI assistance, and a second exam condition in which educators evaluate radiograph pairs with AI-generated labels (e.g., red for inconsistent, yellow for inconclusive, green for consistent). In the evaluation, each exam condition included intentionally manipulated pairs to simulate inconsistencies. This methodology was used with 15 dental educators, each exam condition included 15 radiograph pairs with three intentionally manipulated pairs. Without AI support, the educators identified 12.82% of manipulated radiographs, whereas with AI guidance provided using the AI-based analysis system implemented using mechanisms described herein, accuracy increased to 63.89%. Additionally, overall review time increased when AI-generated labels were provided (e.g., from approximately 143 seconds to approximately 264 seconds in the example evaluation), which likely reflects additional cognitive effort to assess flagged cases.

### Further Examples Having a Variety of Features

1. A system for detecting a pair of anomalous images, the system comprising: one or more hardware processors configured to: receive a first image that includes one or more objects; receive a second image that includes one or more objects; provide the first image and the second image as input to a trained machine learning model that is trained to predict whether the same object is included in both the first image and the second image; receive, from the trained machine learning model, an output indicative of whether the first image and the second image include the same object; cause information indicating whether the first image and the second image include the same object to be presented to a user.

2. The system of clause 1, further comprising: a radiograph device, wherein the second image is a radiograph captured using the radiograph device; wherein the one or more hardware processors are further configured to: capture the second image using the radiograph device.

3. The system of any one of clauses 1 to 2, wherein the first image is a radiograph that includes a first representation of a tooth before a treatment procedure is performed, and the second image is a radiograph the includes a second representation of a tooth after at least a portion of the treatment procedure has been performed.

4. The system of clause 3, wherein the output is indicative of whether the first representation of the tooth and the second representation of the tooth are representations of a first tooth.

5. The system of clause 4, wherein the treatment procedure is a nonsurgical root canal treatment.

6. The system of clause 5, wherein the first tooth is a plastic tooth, and the nonsurgical root canal treatment is part of a practical examination.

7. The system of clause 6, wherein the one or more hardware processors are further configured to: receive a plurality of radiographs, including the first image and the second image, wherein each of the plurality of radiographs represents a tooth at a different stage of the nonsurgical root canal treatment, with the first image representing an intact preoperative tooth, the second image representing a tooth after as portion of the nonsurgical root canal treatment has been completed, and a third radiograph of the plurality of radiographs representing a tooth after the nonsurgical root canal treatment has been completed; receive, from the trained machine learning model, a second output indicative of whether the first image and the third radiograph include the same object, wherein the output comprises a first similarity score, and the second output comprises a second similarity score; and determine that the second similarity score satisfies a criterion, wherein the criterion is based on a comparison to a threshold similarity score; and in response to determining that the second similarity satisfies the criterion, indicate that the tooth represented in the first image is different than the tooth represented in the third radiograph, thereby indicating that at least one pair of radiographs in the plurality of radiographs is anomalous.

8. The system of any one of clauses 1 to 7, wherein the trained machine learning model comprises: a convolutional neural network configured to receive an image as an input, and generate an embedding vector for the received image as an output; a lambda layer configured to determine an L1 distance between the embedding vector and a second embedding vector; and a dense layer configured to generate a similarity score based on the L1 distance between the embedding vector and the second embedding vector.

9. The system of clause 8, wherein the trained machine learning model comprises: a second convolutional neural network configured to receive an image as an input, and generate the second embedding vector for the received image as an output, wherein the second convolutional neural network is identical to the convolutional neural network.

10. The system of any one of clauses 8 to 9, wherein the convolutional neural network comprises: a plurality of convolutional layers, including a first convolutional layer and a last convolutional layer; a plurality of batch normalization layers, each of the plurality of batch normalization layers configured to receive, as input, an output of a corresponding convolutional layer of the plurality of convolutional layers, including a first batch normalization layer configured to receive an output of the first convolutional layer and a last batch normalization layer configured to receive an output of the last convolutional layer; a flatten layer configured to receive, as input, an output of the last batch normalization layer; and a dense layer configured to output the embedding vector based on the output of the flatten layer.

11. The system of any one of clauses 1 to 10, wherein the first image is a radiograph associated with a first subject, and the second image is a radiograph associated with a second subject.

12. The system of clause 11, wherein the output comprises a similarity score, and wherein the one or more hardware processors are further configured to: determine that the similarity score satisfies a criterion, wherein the criterion is based on a comparison to a threshold similarity score; and in response to determining that the similarity score satisfies the criterion, indicate that the first image and the second image include representations of the same object of interest, thereby indicating that the first image and second image are an anomalous pair of radiographs.

13. A method for detecting a pair of anomalous images, the method comprising: receiving a first image that includes one or more objects; receiving a second image that includes one or more objects; providing the first image and the second image as input to a trained machine learning model that is trained to predict whether the same object is included in both the first image and the second image; receiving, from the trained machine learning model, an output indicative of whether the first image and the second image include the same object; causing information indicating whether the first image and the second image include the same object to be presented to a user.

14. The method of clause 13, further comprising: capturing the second image using a radiograph device, wherein the second image is a radiograph captured using the radiograph device.

15. The method of any one of clauses 13 to 14, wherein the first image is a radiograph that includes a first representation of a tooth before a treatment procedure is performed, and the second image is a radiograph the includes a second representation of a tooth after at least a portion of the treatment procedure has been performed.

16. The method of clause 15, wherein the output is indicative of whether the first representation of the tooth and the second representation of the tooth are representations of a first tooth.

17. The method of any one of clauses 15 to 16, wherein the treatment procedure is a nonsurgical root canal treatment.

18. The method of clause 17, wherein the first tooth is a plastic tooth, and the nonsurgical root canal treatment is part of a practical examination.

19. The method of clause 18, further comprising: receiving a plurality of radiographs, including the first image and the second image, wherein each of the plurality of radiographs represents a tooth at a different stage of the nonsurgical root canal treatment, with the first image representing an intact preoperative tooth, the second image representing a tooth after a portion of the nonsurgical root canal treatment has been completed, and a third radiograph of the plurality of radiographs representing a tooth after the nonsurgical root canal treatment has been completed; receiving, from the trained machine learning model, a second output indicative of whether the first image and the third radiograph include the same object, wherein the output comprises a first similarity score, and the second output comprises a second similarity score; and determining that the second similarity score satisfies a criterion, wherein the criterion is based on a comparison to a threshold similarity score; and in response to determining that the second similarity satisfies the criterion, indicating that the tooth represented in the first image is different than the tooth represented in the third radiograph, thereby indicating that at least one pair of radiographs in the plurality of radiographs is anomalous.

20. The method of any one of clauses 13 to 19, wherein the trained machine learning model comprises: a convolutional neural network configured to receive an image as an input, and generate an embedding vector for the received image as an output; a lambda layer configured to determine an L1 distance between the embedding vector and a second embedding vector; and a dense layer configured to generate a similarity score based on the L1 distance between the embedding vector and the second embedding vector.

21. The method of clause 20, wherein the trained machine learning model comprises: a second convolutional neural network configured to receive an image as an input, and generate the second embedding vector for the received image as an output, wherein the second convolutional neural network is identical to the convolutional neural network.

22. The method of any one of clauses 20 to 21, wherein the convolutional neural network comprises: a plurality of convolutional layers, including a first convolutional layer and a last convolutional layer; a plurality of batch normalization layers, each of the plurality of batch normalization layers configured to receive, as input, an output of a corresponding convolutional layer of the plurality of convolutional layers, including a first batch normalization layer configured to receive an output of the first convolutional layer and a last batch normalization layer configured to receive an output of the last convolutional layer; a flatten layer configured to receive, as input, an output of the last batch normalization layer; and a dense layer configured to output the embedding vector based on the output of the flatten layer.

23. The method of any one of clauses 13 to 22, wherein the first image is a radiograph associated with a first subject, and the second image is a radiograph associated with a second subject.

24. The method of clause 23, wherein the output comprises a similarity score, and wherein the method further comprises: determining that the similarity score satisfies a criterion, wherein the criterion is based on a comparison to a threshold similarity score; and in response to determining that the similarity score satisfies the criterion, indicating that the first image and the second image include representations of the same object of interest, thereby indicating that the first image and second image are an anomalous pair of radiographs.

25. A non-transitory computer-readable medium storing computer-executable code, comprising code for causing a computer to cause a processor to: perform a method of any of one of clauses 13 to 24.

In some embodiments, any suitable computer readable media can be used for storing instructions for performing functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that above-described steps of the process of FIGS. 5, 6, and 7 can be executed or performed in any suitable order or sequence not limited to the order and sequence shown and described in the figures. Also, some of the above steps of the process of FIGS. 5, 6, and 7 can be executed or performed substantially simultaneously where appropriate or in parallel to reduce latency and processing times.

This written description uses examples to disclose the invention(s), including the best mode, and also to enable any person skilled in the art to make and use the invention(s). Certain terms have been used for brevity, clarity, and understanding. No unnecessary limitations are to be inferred therefrom beyond the requirement of the prior art because such terms are used for descriptive purposes only and are intended to be broadly construed. The patentable scope of the invention(s) is defined by the claims and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

What is claimed is:

1. A system for detecting a pair of anomalous images, the system comprising:
one or more hardware processors configured to:
receive a first image that includes one or more objects;
receive a second image that includes one or more objects;
provide the first image and the second image as input to a trained machine learning model that is trained to predict whether the same object is included in both the first image and the second image;
receive, from the trained machine learning model, an output indicative of whether the first image and the second image include the same object;
cause information indicating whether the first image and the second image include the same object to be presented to a user.

2. The system of claim 1, further comprising:
a radiograph device, wherein the second image is a radiograph captured using the radiograph device;
wherein the one or more hardware processors are further configured to:
capture the second image using the radiograph device.

3. The system of claim 1, wherein the first image is a radiograph that includes a first representation of a tooth before a treatment procedure is performed, and the second image is a radiograph the includes a second representation of a tooth after at least a portion of the treatment procedure has been performed.

4. The system of claim 3, wherein the output is indicative of whether the first representation of the tooth and the second representation of the tooth are representations of a first tooth.

5. The system of claim 4, wherein the treatment procedure is a nonsurgical root canal treatment.

6. The system of claim 5, wherein the first tooth is a plastic tooth, and the nonsurgical root canal treatment is part of a practical examination.

7. The system of claim 6, wherein the one or more hardware processors are further configured to:
receive a plurality of radiographs, including the first image and the second image,
wherein each of the plurality of radiographs represents a tooth at a different stage of the nonsurgical root canal treatment, with the first image representing an intact preoperative tooth, the second image representing a tooth after as portion of the nonsurgical root canal treatment has been completed, and a third radiograph of the plurality of radiographs representing a tooth after the nonsurgical root canal treatment has been completed;
receive, from the trained machine learning model, a second output indicative of whether the first image and the third radiograph include the same object,
wherein the output comprises a first similarity score, and the second output comprises a second similarity score; and
determine that the second similarity score satisfies a criterion,
wherein the criterion is based on a comparison to a threshold similarity score; and
in response to determining that the second similarity satisfies the criterion, indicate that the tooth represented in the first image is different than the tooth represented in the third radiograph, thereby indicating that at least one pair of radiographs in the plurality of radiographs is anomalous.

8. The system of claim 1, wherein the trained machine learning model comprises:
a convolutional neural network configured to receive an image as an input, and generate an embedding vector for the received image as an output;
a lambda layer configured to determine an L1 distance between the embedding vector and a second embedding vector; and
a dense layer configured to generate a similarity score based on the L1 distance between the embedding vector and the second embedding vector.

9. The system of claim 8, wherein the trained machine learning model comprises:
a second convolutional neural network configured to receive an image as an input, and generate the second embedding vector for the received image as an output,
wherein the second convolutional neural network is identical to the convolutional neural network.

10. The system of claim 8, wherein the convolutional neural network comprises:
a plurality of convolutional layers, including a first convolutional layer and a last convolutional layer;
a plurality of batch normalization layers, each of the plurality of batch normalization layers configured to receive, as input, an output of a corresponding convolutional layer of the plurality of convolutional layers, including a first batch normalization layer configured to receive an output of the first convolutional layer and a last batch normalization layer configured to receive an output of the last convolutional layer;
a flatten layer configured to receive, as input, an output of the last batch normalization layer; and
a dense layer configured to output the embedding vector based on the output of the flatten layer.

11. The system of claim 1, wherein the first image is a radiograph associated with a first subject, and the second image is a radiograph associated with a second subject.

12. The system of claim 11, wherein the output comprises a similarity score, and wherein the one or more hardware processors are further configured to:
determine that the similarity score satisfies a criterion,
wherein the criterion is based on a comparison to a threshold similarity score; and
in response to determining that the similarity score satisfies the criterion, indicate that the first image and the second image include representations of the same object of interest, thereby indicating that the first image and second image are an anomalous pair of radiographs.

13. A method for detecting a pair of anomalous images, the method comprising:
receiving a first image that includes one or more objects;
receiving a second image that includes one or more objects;
providing the first image and the second image as input to a trained machine learning model that is trained to predict whether the same object is included in both the first image and the second image;
receiving, from the trained machine learning model, an output indicative of whether the first image and the second image include the same object;
causing information indicating whether the first image and the second image include the same object to be presented to a user.

14. The method of claim 13, further comprising:
capturing the second image using a radiograph device,
wherein the second image is a radiograph captured using the radiograph device.

15. The method of claim 13, wherein the first image is a radiograph that includes a first representation of a tooth before a treatment procedure is performed, and the second image is a radiograph the includes a second representation of a tooth after at least a portion of the treatment procedure has been performed.

16. The method of claim 15, wherein the output is indicative of whether the first representation of the tooth and the second representation of the tooth are representations of a first tooth.

17. The method of claim 16, wherein the treatment procedure is a nonsurgical root canal treatment.

18. The method of claim 17, wherein the first tooth is a plastic tooth, and the nonsurgical root canal treatment is part of a practical examination.

19. The method of claim 18, further comprising:
receiving a plurality of radiographs, including the first image and the second image,
wherein each of the plurality of radiographs represents a tooth at a different stage of the nonsurgical root canal treatment, with the first image representing an intact preoperative tooth, the second image representing a tooth after a portion of the nonsurgical root canal treatment has been completed, and a third radiograph of the plurality of radiographs representing a tooth after the nonsurgical root canal treatment has been completed;
receiving, from the trained machine learning model, a second output indicative of whether the first image and the third radiograph include the same object,
wherein the output comprises a first similarity score, and the second output comprises a second similarity score; and
determining that the second similarity score satisfies a criterion,
wherein the criterion is based on a comparison to a threshold similarity score; and
in response to determining that the second similarity satisfies the criterion, indicating that the tooth represented in the first image is different than the tooth represented in the third radiograph, thereby indicating that at least one pair of radiographs in the plurality of radiographs is anomalous.

20. A non-transitory computer-readable medium having instructions stored thereon, wherein the instructions, when executed by one or more hardware processors, cause the one or more hardware processors to:
receive a first image that includes one or more objects;
receive a second image that includes one or more objects;
provide the first image and the second image as input to a trained machine learning model that is trained to predict whether the same object is included in both the first image and the second image;
receive, from the trained machine learning model, an output indicative of whether the first image and the second image include the same object;
cause information indicating whether the first image and the second image include the same object to be presented to a user.
